(19) United States
(12) Patent Application Publication
(10) Pub. No.: US 2017/0222217 A1
(43) Pub. Date: Aug. 3, 2017

(54) CARBON-ENRICHED OPEN FRAMEWORK COMPOSITES, METHODS FOR PRODUCING AND USING SUCH COMPOSITES

(71) Applicant: NIVO SYSTEMS, INC., Culver City, CA (US)

(72) Inventor: Bo WANG, Bejing (CN)

(73) Assignee: NIVO SYSTEMS, INC., Culver City, CA (US)

(21) Appl. No.: 15/307,327

(22) PCT Filed: May 5, 2015
(86) PCT No.: PCT/US2015/029244

§ 371 Date: Oct. 27, 2016

Related U.S. Application Data
(60) Provisional application No. 61/988,695, filed on May 5, 2014.

(51) Int. Cl. H01M 4/36; H01M 10/0525; H01M 4/485; H01M 4/04; H01M 4/133; H01M 4/1393; H01M 4/1391; H01M 4/587; H01M 4/131

(52) U.S. Cl. CPC H01M 4/364; H01M 4/587; H01M 10/0525; H01M 4/485; H01M 4/131; H01M 4/133; H01M 4/1393; H01M 4/1391; H01M 4/0471

(57) ABSTRACT

Provided herein are composites made up of carbon-enriched open frameworks, and mechanochemical methods of producing such composites. Such open frameworks may include metal-organic frameworks (MOFs), including for example zeolitic imidazolate frameworks (ZIFs). Such composites may be suitable for use as electrode materials, or more specifically for use in batteries.

### CROSS-REFERENCE TO RELATED APPLICATIONS

This application claims priority to U.S. Provisional Patent Application No. 61/988,695, filed May 5, 2014, which is incorporated herein by reference in its entirety.

### FIELD

The present disclosure relates generally to carbon-enriched open framework composites, and more specifically to composites with carbon-enriched open frameworks, such as carbon-enriched metal-organic frameworks (including zeolitic imidazolate frameworks) suitable for use in batteries.

### BACKGROUND

Rechargeable lithium-ion batteries are often used in portable wireless devices, such as mobile phones, laptops and digital cameras. However, the energy densities of current lithium-ion batteries have been found insufficient to power electric vehicles (EVs). As a result, lithium-ion batteries are typically used in stationary electricity storage.

Lithium batteries have the potential to satisfy the growing demands for portable wireless devices and electric vehicles. For example, Li—S batteries have a theoretical capacity of 1,675 mAh/g, which is more than five times that of conventional lithium-ion batteries based on intercalation electrodes, and a specific energy of 2,600 Wh/kg. Despite the above advantages stated above, Li—S batteries face fundamental challenges. For example, the dissolution of polysulfides into the electrolyte of the battery can cause a reaction with the Li anode resulting in active mass loss, or random redeposition at the cathode surface terminating the electrochemical reactions.

Thus, there exists a need in the art to produce lithium batteries with enhanced the battery capacity, improved the chemical stability and cyclability, and decreased internal impedance.

### BRIEF SUMMARY

Provided herein are enriched open framework composites, such as enriched metal-organic framework (MOF) composites, for use in batteries, including lithium-ion batteries. Provided herein are also methods for producing such composites, which are made up of porous open framework formed from organic linking moieties bridged by multidentate organic or inorganic cores. As used herein, “core” refers to a repeating unit or units found in a framework. The framework may include a homogenous repeating core or a heterogeneous repeating core structure. A core includes a metal and a linking moiety. A plurality of cores linked together forms a framework.

In one aspect, provided are methods that involve mechanochemically processing (i) one or more organic linking compounds, (ii) one or more metal compounds, and (iii) carbonaceous material to produce the carbon-enriched composite. The mechanochemical processing may involve grinding or stirring to produce the composites. Additionally, in some embodiments, the methods provided may be “one-pot” methods, in which the formation of open framework and the incorporation of additional carbonaceous materials into the open framework formed (e.g., covering the surface of the open framework and/or or incorporated within the channels or pores of the open framework) occur in the same step. Thus, in one aspect, provided is a mechanochemical method for producing a composite, by grinding a mixture that includes (i) one or more organic linking compounds, (ii) one or more metal compounds, and (iii) carbonaceous material to produce the carbon-enriched composite. In another aspect, provided is a mechanochemical method for producing a composite, by stirring a mixture that includes (i) one or more organic linking compounds, (ii) one or more metal compounds, and (iii) carbonaceous material to produce the carbon-enriched composite.

In other aspects, the method may involve: (a) mechanochemically processing a mixture of one or more organic linking compounds and one or more metal compounds, then (b) adding carbonaceous material to the mixture, and (c) mechanochemically processing the mixture to produce the composite. As discussed above, in certain embodiments, the mechanochemically processing may involve grinding or stirring.

The composite produced from the methods described above includes an open framework formed from the one or more organic linking compounds and the one or more metal compounds, and such open framework is enriched by the incorporation of carbonaceous material. The carbonaceous material has at least one nitrogen atom, at least one sulfur atom, at least one —OH moiety, at least one —COOH moiety, or any combinations thereof, which coordinates with at least one of the metal ions in the open framework. In some embodiments, the methods described above may involve further heating (e.g., to carbonize) the composite produced from mechanochemically processing.

The composites may include metal-organic frameworks (MOFs), including for example zeolitic imidazolate frameworks (ZIFs). MOFs are porous materials assembled by coordination of metal ions and organic linking compounds. ZIFs are a class of MOFs that are topologically isomorphic with zeolites. ZIFs may be made up of tetrahedrally-coordinated metal ions connected by organic imidazole linkers (or derivatives thereof). Examples of suitable MOFs, including ZIFs, may include ZIF-8, ZIF-67, and MOF-199.

The methods provided herein may produce composites of certain sizes (particle sizes), which make them suitable for use, for example, as active electrode materials in batteries (e.g., Li-ion batteries) and other applications.

Thus, provided is also an electrode made up of a composite provided herein or produced according to the methods described herein; carbonaceous material; and binder. In some embodiments, the electrode is an anode. In other embodiments, the electrode is a cathode.

Provided is also a battery made up of any of the electrodes described herein; and lithium ions.

### DESCRIPTION OF THE FIGURES

The present application can be understood by reference to the following description taken in conjunction with the accompanying figures.

FIGS. 1A-1D depict four exemplary MOFs: ZIF-8 (FIG. 1A), HKUST-1 (FIG. 1B), MIL-53 (Al) (FIG. 1C), and NH₂-MIL-53 (Al) (FIG. 1D). The sphere in the middle of a MOF depicts the void space of the MOF.

FIG. 2 shows PXRD patterns of ZIF-8: pattern (a) depicts a PXRD pattern of ZIF-8 as synthesized in Comparative Example 1a below; and pattern (b) depicts a PXRD pattern simulated from the single crystal x-ray diffraction data of the control MOF obtained from the Cambridge Crystallographic Data Centre.

FIG. 3 shows PXRD patterns of carbonized ZIF-8: pattern (a) depicts a PXRD pattern of ZIF-8 carbonized at 700° C. under nitrogen (“ZIF-8-700N”); pattern (b) depicts a PXRD pattern of ZIF-8 carbonized at 800° C. under nitrogen (“ZIF-8-800N”); and pattern (c) depicts a PXRD pattern of ZIF-8 carbonized at 900° C. under nitrogen (“ZIF-8-900N”).

FIG. 4A shows the cycle test of the ZIF-8 carbonized at (a) 700° C. under nitrogen (“ZIF-8-700N”); (b) 800° C. under nitrogen (“ZIF-8-800N”); and (c) 900° C. under nitrogen (“ZIF-8-900N”).

FIG. 4B shows the discharging profile of ZIF-8-800N.

FIG. 4C shows a graph depicting the cyclic voltammetry of ZIF-8-800N.

FIG. 5A shows PXRD patterns of various carbon-enriched ZIF-8. Pattern (a) depicts a PXRD pattern of citrate-enriched ZIF-8. Pattern (b) depicts a PXRD pattern of glucose-enriched ZIF-8. Pattern (c) depicts a PXRD pattern of pyrrole-enriched ZIF-8. Pattern (d) depicts a PXRD pattern of β-cyclodextrin-enriched ZIF-8. Pattern (e) depicts a PXRD pattern of chitosan-enriched ZIF-8. Pattern (f) depicts a PXRD pattern of ZIF-8 as prepared according in Comparative Example 1a.

FIG. 5B shows FT-IR spectra of (a) chitosan, (b) ZIF-8, and (c) chitosan-enriched ZIF-8 composite.

FIG. 6A shows a nitrogen sorption isotherm of chitosan-enriched ZIF-8 carbonized under 800° C. under nitrogen.

FIG. 6B shows a pore size distribution graph calculated by DFT of chitosan-enriched ZIF-8 carbonized at 800° C. under nitrogen.

FIG. 6C shows an electrochemical impedance spectrum of pyrrole-enriched ZIF-8 carbonized at 800° C. under nitrogen (“Pyrrole-ZIF-8-800N”).

FIG. 6D shows an electrochemical impedance spectrum of citrate-enriched ZIF-8 carbonized at 800° C. under nitrogen (“Citrate-ZIF-8-800N”).

FIG. 6E shows an electrochemical impedance spectrum of glucose-enriched ZIF-8 carbonized at 800° C. under nitrogen (“Glucose-ZIF-8-800N”).

FIG. 7 shows a graph depicting cycling performance, comparing long-term cyclabilities of (a) ZnO, (b) ZIF-8 carbonized at 800° C. under nitrogen, and (c) chitosan-enriched ZIF-8 carbonized under 800° C. under nitrogen.

FIG. 8 shows electrochemical impedance spectra of ZnO, ZIF-8 carbonized at 800° C. under nitrogen, and chitosan-enriched ZIF-8 carbonized under 800° C. under nitrogen.

FIG. 9 shows a graph depicting the discharge/charge profiles (corresponding to ascending and descending curves respectively with respect to increasing specific capacity) of chitosan-enriched ZIF-8 carbonized under 800° C. under nitrogen at 0.1 C over 1, 5, 10, 20 and 50 cycles.

FIGS. 10A-10D compare long-term cyclabilities of various carbonized carbon-enriched ZIF-8, showing graph depicting cycling performance of glucose-enriched (FIG. 10A), citric acid-enriched (FIG. 10B), pyrrole-enriched (FIG. 10C), and β-cyclodextrin-enriched (FIG. 10D) ZIF-8, each carbonized at 800° C. under nitrogen.

FIGS. 11A-11D show graphs depicting the discharge/charge profiles (corresponding to ascending and descending curves respectively with respect to increasing specific capacity) of glucose-enriched (FIG. 11A), citric acid-enriched (FIG. 11B), pyrrole-enriched (FIG. 11C), and β-cyclodextrin-enriched (FIG. 11D) ZIF-8, each carbonized at 800° C. under nitrogen.

FIG. 12 depicts an exemplary lithium-ion (Li-ion) battery, in which the anode is made up of carbon-enriched MOF. It should be understood that the size of the cathode and anode relative to the battery is not drawn to scale.

FIG. 13 depicts an exemplary process for preparing a carbonized chitosan-enriched ZIF-8 composite. It should be understood that “2-mlm” refers to 2-methyl imidazole.

### DETAILED DESCRIPTION

The following description sets forth exemplary compositions, methods, parameters and the like. It should be recognized, however, that such description is not intended as a limitation on the scope of the present disclosure but is instead provided as a description of exemplary embodiments.

The present disclosure provides composites made up of carbon-enriched open frameworks. Such open frameworks include metal-organic frameworks (MOFs), including for example zeolitic imidazolate frameworks (ZIFs). The open frameworks described herein are enriched by incorporating an additional carbonaceous material. The carbonaceous material has at least one nitrogen atom, at least one sulfur atom, at least one -OH moiety, at least one —COOH moiety, or any combinations thereof, which coordinates with at least one of the metal ions of the open framework. The additional carbonaceous material may cover the surface of the open framework, and/or occupy at least a portion of the one or more pores or channels of the open framework. Such composites may be suitable for use as electrode materials in batteries, such as Li-ion batteries, and other applications.

As used herein, “MOF composite” refers to a carbon-enriched MOF, in which the carbonaceous material covers at least a portion of the surface of the MOF, and/or is incorporated into at least a portion of the pores or channels of the MOF. As used herein, “ZIF composite” refers to a carbon-enriched ZIF, in which the carbonaceous material covers at least a portion of the surface of the ZIF, and/or is incorporated into at least a portion of the pores or channels of the ZIF.

The present disclosure provides mechanochemical methods for producing such composites. The methods may include mechanochemically processing (i) organic linking compounds, (ii) metal compounds, and (iii) carbonaceous material to produce a carbon-enriched composite. As used herein, “mechanochemical processing” refers to the use of mechanical energy to activate chemical reactions and structural changes. Mechanochemical processing may involve, for example, grinding or stirring. Such mechanochemical methods described herein are different from methods known in the art to generally synthesize open framework, which may typically involve hydrothermal and solvothermal synthesis. It should be understood, however, that the mechanochemical methods provided may include one or more subsequent steps after the mechanochemical formation of the carbon-enriched open frameworks.

Such mechanochemical methods described herein may be one-pot methods for producing such carbon-enriched composites by forming the open frameworks and enriching the open frameworks with additional carbonaceous material in the same step, by mechanochemically processing (i) one or more organic linking compounds, (ii) one or more metal compounds, and (iii) carbonaceous material to produce the carbon-enriched composite. The formation of the open frameworks and the carbon enrichment of such open frameworks occur in one step.

The methods provided may be used for any class of open frameworks, including zeolitic imidazolate frameworks (ZIFs) and other metal organic frameworks (MOFs), and all possible resulting net topologies (including any net topologies known to one of skill in reticular chemistry).

The methods provided herein (including the one-pot mechanochemical methods) produce composites with sizes (particle sizes) that unexpectedly improve capacity retention and life cycle of the material.

The methods for producing such composites, the structure and properties of the composites, and their uses are described in further detail below.

### Methods of Producing the Composites

Provided herein are methods that involve mechanochemically processing (i) one or more organic linking compounds, (ii) one or more metal compounds, and (iii) carbonaceous material to produce the carbon-enriched composite. In certain aspects, the methods may be performed in “one-pot”, such that the (i) one or more organic linking compounds, (ii) one or more metal compounds, and (iii) carbonaceous material to produce the carbon-enriched composite are mechanochemically processed together in the same step. The mechanochemical processing may involve grinding or stirring. Thus, in one aspect, provided is a the method that involves grinding a mixture that includes (i) one or more organic linking compounds, (ii) one or more metal compounds, and (iii) carbonaceous material to produce the carbon-enriched composites described herein. In another aspect, provided is a the method that involves stirring a mixture that includes (i) one or more organic linking compounds, (ii) one or more metal compounds, and (iii) carbonaceous material to produce the carbon-enriched composites described herein. The mechanochemically processing (e.g., grinding or stirring) may be performed in a liquid medium. Additionally, the mechanochemically processing may be performed without the addition of external heat.

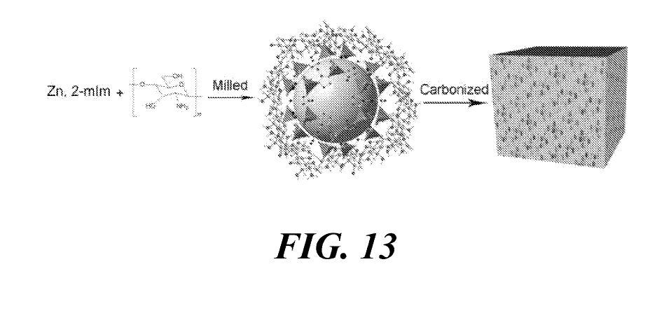

The mechanochemically processing yields a composite made up of an open framework formed from the one or more organic linking compounds and the one or more metal compounds. The open framework has one or more metal ions, and certain functional groups of the carbonaceous material coordinates with at least one of the metal ions. In some embodiments, the method may further include heating (e.g., to carbonize) the composite obtained from the mechanochemically processing step. For example, FIG. 13 provides an exemplary process for preparing a carbonized chitosan-enriched ZIF-8 composite.

Grinding

Any suitable methods and techniques known in the art may be used to grind the (i) one or more organic linking compounds, (ii) one or more metal compounds, and (iii) carbonaceous material. In one embodiment of the method, the grinding may be performed using a ball mill. For example, a high-energy ball mill machine may be used. The frequency of the ball mill machine may vary, and is expressed as the rate at which the mixture will be rotated and/or shaken with the balls of the machine. In one variation of the method, grinding is performed using a ball mill at a frequency of between 5 Hz and 60 Hz, between 10 Hz and 50 Hz, between 10 Hz and 30 Hz, or between 10 Hz and 20 Hz. In another variation, grinding is performed using a ball mill operating between 600 rmp to 1200 rmp.

In the mechanochemical methods, the grinding of (i) one or more organic linking compounds, (ii) one or more metal compounds, and (iii) carbonaceous material may produce intrinsic heat, which may help with the formation of the composite. The intrinsic heat may, for example, cause the reaction to take place a temperature between room temperature and 60° C., between room temperature and 55° C., between room temperature and 50° C., between room temperature and 55° C., between room temperature and 40° C., between room temperature and 45° C., or between room temperature and 30° C.; or at about room temperature. In certain embodiments, the composite is produced at a temperature below 60° C., below 55° C., below 50° C., below 55° C., below 40° C., below 45° C., or below 30° C.; or at about room temperature. In some embodiments of the method, grinding is performed without external heating.

The amount of time used for the grinding also may impact the formation of the composites, including, for example, the distribution of the additional carbonaceous material enriching the open frameworks formed from the organic linking compounds and the metal compounds. In some embodiments of the method, the grinding is performed for at least 1 minute, at least 5 minutes, at least 10 minutes, at least 20 minutes, at least 30 minutes, at least 60 minutes, at least 120 minutes, at least 240 minutes, or at least 480 minutes; or between 5 minutes and 1000 minutes, between 5 minutes and 720 minutes, or between 5 minutes and 120 minutes.

The grinding may be performed under inert atmosphere. For example, the grinding of the mixture may be performed in the presence of an inert gas, such as argon or nitrogen. The grinding under inert atmosphere may help reduce the impurities produced.

Grinding may be employed to produce composites having any type of open frameworks enriched by additional carbonaceous material. For example, in some embodiments, grinding is used to produce composites with ZIFs (e.g., ZIF-8, ZIF-67) enriched by additional carbonaceous material. In certain embodiments, grinding is performed in the absence of solvent.

Stirring

Any suitable methods and techniques known in the art may be used to stir (i) one or more organic linking compounds, (ii) one or more metal compounds, and (iii) carbonaceous material. Stirring may be performed in a liquid medium, as discussed in further detail below. Stirring may be performed using any suitable apparatus known in the art. For example, stirring may be carried out using a stir bar or a mechanical stirrer (e.g., paddle, stir motor).

In the mechanochemical methods, the stirring of (i) one or more organic linking compounds, (ii) one or more metal compounds, and (iii) carbonaceous material may produce intrinsic heat, which may help with the formation of the composite. In certain embodiments, the composite is produced at a temperature below 30° C. or at about room temperature. In some embodiments of the method, stirring is performed without external heating.

The amount of time used for the stirring also may impact the formation of the composites, including, for example, the distribution of the additional carbonaceous material enriching the open frameworks formed from the organic linking compounds and the metal compounds. In some embodiments of the method, the stirring is performed for at least 1 minute, at least 5 minutes, at least 10 minutes, at least 20 minutes, at least 30 minutes, at least 60 minutes, at least 120 minutes, at least 240 minutes, or at least 480 minutes; or between 5 minutes and 1000 minutes, between 5 minutes and 720 minutes, or between 5 minutes and 120 minutes.

The stirring may be performed under inert atmosphere. For example, the stirring of the mixture may be performed in the presence of an inert gas, such as argon or nitrogen. The stirring under inert atmosphere may help reduce the impurities produced.

Stirring may be employed to produce composites having any type of carbon-enriched open frameworks. For example, in certain embodiments, stirring is used to produce composites with MOFs (e.g., MOF-5, MOF-199) enriched by additional carbonaceous material.

Organic Linking Compounds

As used herein, “linking compound” refers to a monodentate or a bidendate compound that can bind to a metal or a plurality of metals. Various organic linking compounds may be used in the methods described herein. The organic linking compounds may be obtained from any commercially available sources, or prepared using any methods or techniques generally known in the art.

Organic linking compounds known in the art suitable for forming open frameworks may also be used. It should be understood that the types of organic linking compounds selected for use in the methods will determine the type of organic framework formed in the composite.

In some embodiments of the method where the organic framework of the composite produced is ZIF, the organic linking compound used in the method may be a monocyclic five-membered heteroaryl having at least two nitrogen atoms, wherein two of the nitrogen atoms are configured in the 1- and 3-positions of the monocyclic five-membered ring. It should be understood that such monocyclic five-membered ring (which may be optionally substituted) having nitrogen atoms at the 1- and 3-positions of the ring include:

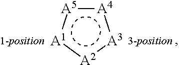

wherein A¹ and A³ are independently N or NH; and A², A⁴ and A⁵ are independently C, CH, N or NH (to the extent that such ring system is chemically feasible). In other embodiments of the method where the organic framework of the composite produced is ZIF, the organic linking compound used in the method may also be a bicyclic ring system made up of at least one five-membered ring having at least two nitrogen atoms, wherein two of the nitrogen atoms are configured in the 1- and 3-positions of the five-membered ring. The bicyclic ring system may further include a second five-membered ring or a six-membered ring fused to the first five-membered ring. It should be understood that such bicyclic ring system (which may be optionally substituted) made up of at least one five-membered ring having nitrogen atoms are configured in the 1- and 3-positions of the five-membered ring may include, for example:

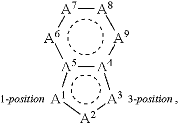

wherein A¹ and A³ are independently N or NH; and A², A⁴-A⁹ are independently C, CH, N or NH (to the extent that such ring system is chemically feasible).

In certain embodiments of the method for producing ZIF composites, the organic linking compound is unsubstituted or substituted imidazole, unsubstituted or substituted benzimidazole, unsubstituted or substituted triazole, unsubstituted or substituted benzotriazole, or unsubstituted or substituted purine (e.g., unsubstituted or substituted guanine, unsubstituted or substituted xanthine, or unsubstituted or substituted hypoxanthine).

Examples of organic linking compounds suitable for use in the mechanochemical methods for producing ZIF composites include:

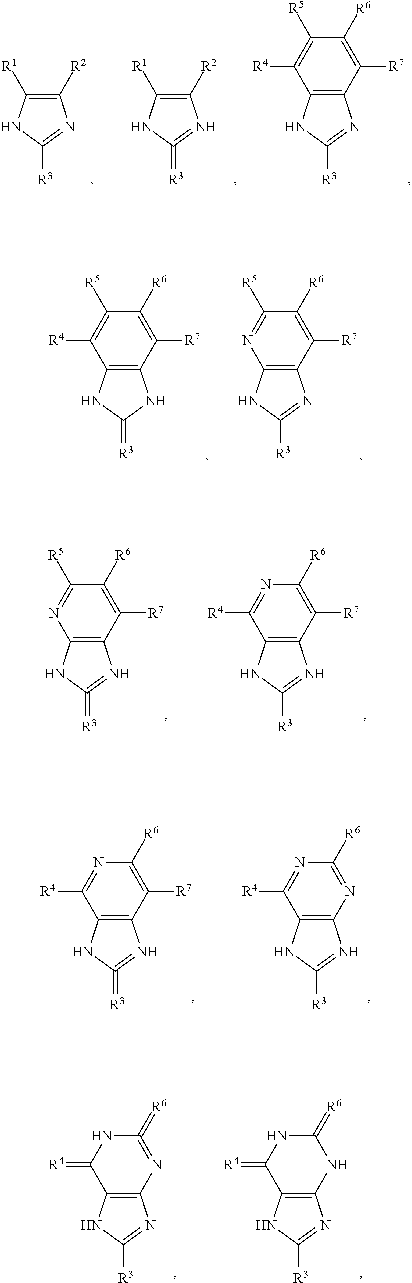

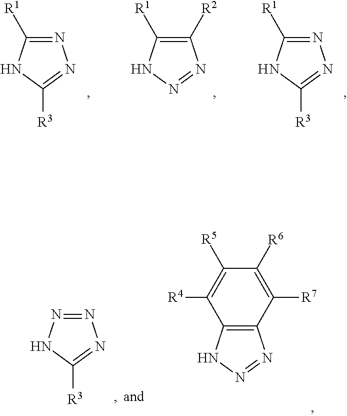

wherein:

each R¹, R², R³, R⁴, R⁵, R⁶ and R⁷ (when present) is independently selected from the group consisting of H, NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, As(SH)₃, CH(R^{a}SH)₂, C(R^{a}SH)₃, CH(R^{a}NH₂)₂, C(R^{a}NH₂)₃, CH(R^{a}OH)₂, C(R^{a}OH)₃, CH(R^{a}CN)₂, C(R^{a}CN)₃,

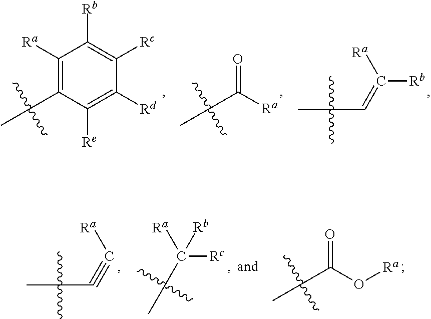

and

each R^{a}, R^{b}, and R^{c} (when present) is independently selected from the group consisting of H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, and As(SH)₃.

In certain embodiments, each R¹, R², R³, R⁴, R⁵, R⁶ and R⁷ (when present) is independently H or

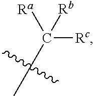

wherein each R^{a}, R^{b}, and R^{c} is H or alkyl alkyl (e.g. C₁₋₂₀ alkyl, or C₁₋₁₀ alkyl, or C₁₋₄ alkyl).

In other embodiments, the organic linking compound may have a structure of formula:

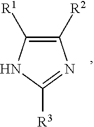

wherein:

each R¹ and R² is independently hydrogen, aryl (e.g., C₅₋₂₀ aryl, or C₅₋₆ aryl), alkyl (e.g. C₁₋₂₀ alkyl, or C₁₋₁₀ alkyl, or C₁₋₄ alkyl), halo (e.g., Cl, F, Br, or I), cyano, or nitro; or R¹ and R² are taken together with the carbon atoms to which they are attached to form a five- or six-membered heterocycle comprising 1, 2, or 3 nitrogen atoms; and

R³ is hydrogen or alkyl.

In certain embodiments, each R¹ and R² is hydrogen. In certain embodiments, each R¹ and R² is independently alkyl (e.g. C₁₋₂₀ alkyl, or C₁₋₁₀ alkyl, or C₁₋₄ alkyl). In certain embodiments, R³ is hydrogen. In certain embodiments, R³ is alkyl (e.g. C₁₋₂₀ alkyl, or C₁₋₁₀ alkyl, or C₁₋₄ alkyl). In one embodiment, R³ is methyl. In certain embodiments, each R¹ and R² is independently alkyl; and R³ is hydrogen. In one embodiment, each R¹ and R² is methyl; and R³ is hydrogen. In certain embodiments, each R¹ and R² is hydrogen; and R³ is alkyl. In one embodiment, each R¹ and R² is hydrogen; and R³ is methyl. In yet another embodiment of the composite, each R¹, R² and R³ is hydrogen.

In certain embodiments, the organic linking compound may have a structure selected from:

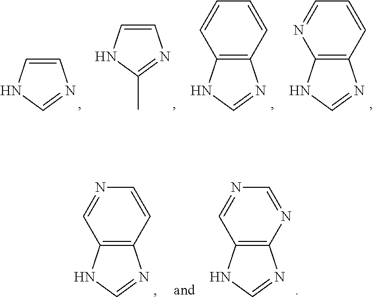

In certain embodiments, the organic linking compound may be an unsubstituted or substituted imidazole. Examples of such organic linking compounds include 2-alkyl imidazole (e.g., 2-methyl imidazole). In certain embodiments, the organic linking compound may an imidazole or imidazole derivative, including for example heterocyclic rings such as unsubstituted imidazole, unsubstituted benzimidazole, or imidazole or benzimidazole substituted with alkyl (e.g. C₁₋₂₀ alkyl, or C₁₋₁₀ alkyl, or C₁₋₄ alkyl), nitro, cyano, or halo (e.g., Cl, F, Br, or I) groups, wherein one or more carbon atoms on the imidazole or benzimidazole may be replaced with a nitrogen atom (to the extent chemically feasible).

In other embodiments of the method where the organic framework of the composite produced is MOF, the organic linking compound used in the method may be an aryl substituted with at least one carboxyl moiety, or a heteroaryl substituted with at least one carboxyl moiety. In certain embodiments, the organic linking compound used in the method may be an aryl with at least one phenyl ring substituted with a —COOH moiety, or a heteroaryl with at least pyridyl ring substituted with a —COOH moiety. In certain embodiments, the organic linking compound is an aryl with 1 to 5 phenyl rings, wherein at least one phenyl ring is substituted with a —COOH moiety, or a heteroaryl with 1 to 5 pyridyl rings, wherein at least pyridyl ring is substituted with a —COOH moiety.

When aryl includes two or more phenyl rings, the phenyl rings may be fused or unfused. When heteroaryl includes two or more pyridyl rings, or at least one pyridyl ring and at least one phenyl ring, such rings may be fused or unfused. It should be understood that aryl does not encompass or overlap in any way with heteroaryl. For example, if a phenyl ring is fused with or connected to a pyridyl ring, the resulting ring system is considered heteroaryl.

Examples of organic linking compounds suitable for use in the mechanochemical methods for producing MOF composites include:

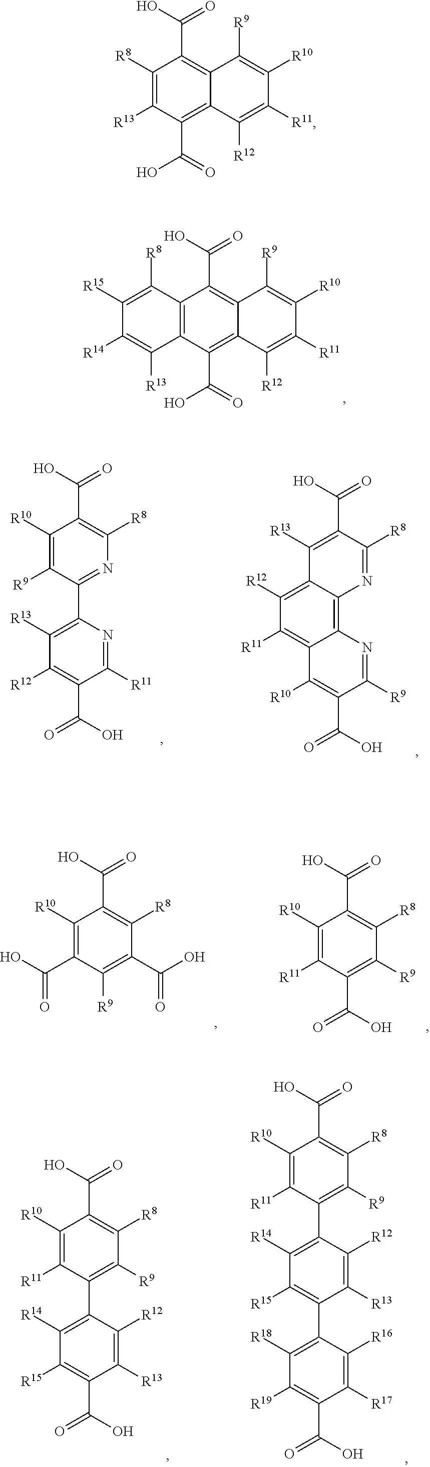

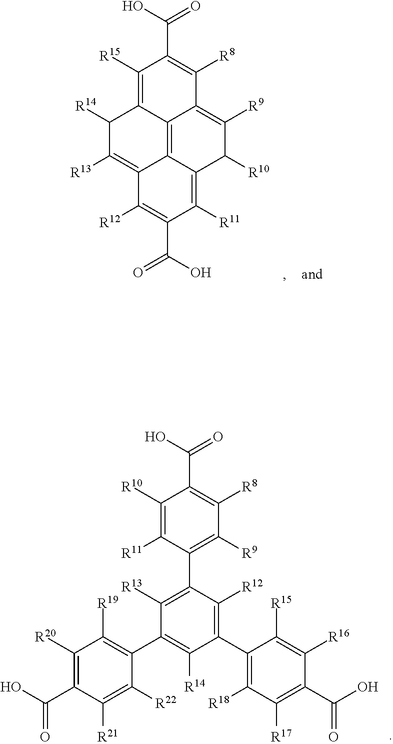

wherein:

each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is independently selected from the group consisting of H, NH₂, CN, OH, ═O, ═S, Br, Cl, I, F,

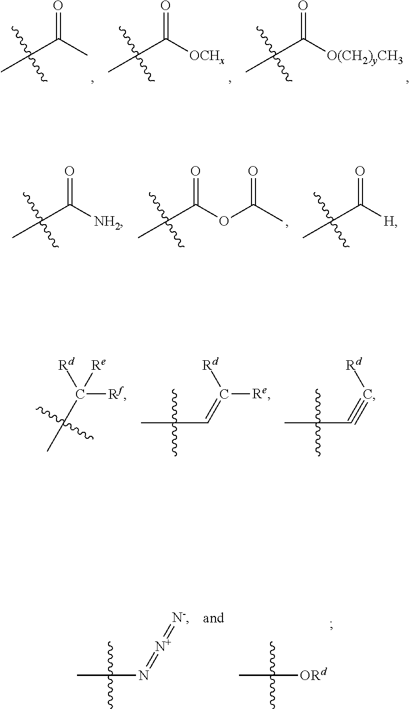

x and y (when present) is independently 1, 2 or 3; and

each R^{d}, R^{e} and R^{f} (when present) is independently H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, or Sn(SH)₄.

In certain embodiments, each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is H.

In certain embodiments of the method for producing MOF composites, the organic linking compound may be an unsubstituted or substituted phenyl compound. The phenyl may, in one embodiment, be substituted with one or more carboxyl substituents. Examples of such organic linking compounds include trimesic acid, terephthalic acid, and 2-amino benzyl dicarboxylic acid.

Metal Compounds

Metal ions can be introduced into the open framework via coordination or complexation with the functionalized organic linking moieties (e.g., imine or N-heterocyclic carbene) in the framework backbones or by ion exchange. The metal ions may be from metal compounds, including metal salts and complexes. Various metal compounds, including metal salts and complexes, may be used in the methods described herein. The metal compounds, including metal salts and complexes, may be obtained from any commercially available sources, or prepared using any methods or techniques generally known in the art.

The metal compound may, for example, be selected from a zinc compound, a copper compound, an aluminum compound, a copper compound, an iron compound, a manganese compound, a titanium compound, a zirconium compound, or other metal compounds having one or more early transition metals (including, for example, Sc, Ti, V, Cr, Mn, Fe, Co, Ni, Cu, and Zn). In one embodiment, the metal compound is zinc oxide, copper acetate, aluminium acetate, zinc acetate or any combination thereof. It should be understood that salts and complexes of such metal compounds may also be used. For example, a dihydrate of zinc acetate, Zn(OAc)₂·2H₂O, may be used as the metal compound in the methods described herein.

The metal compound is made up of one or more metal ions. The metal ions may be transition metal ions. The metal ion(s) of the metal compound may be one that prefers tetrahedral coordination. One such example is Zn²⁺. Thus, in one variation, the metal compound has a Zn²⁺. Other suitable metal ions of the metal compound include, for example, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, or any combinations thereof. In some embodiments, the metal compound has one or more metal ions selected from Zn²⁺, Cu²⁺, Cu⁺, Al³⁺, Cu²⁺, Cu⁺, Fe³⁺, Fe²⁺, Mn³⁺, Mn²⁺, Ti⁴⁺, and Zr⁴⁺. In one embodiment, the metal compound has one or more metal ions selected from Zn²⁺, Cu²⁺, Cu⁺, Al³⁺, Cu²⁺, and Cu⁺.

The metal compound may, in certain instances, have one or more counterions. Suitable counterions may include, for example, acetate, nitrates, chloride, bromides, iodides, fluorides, and sulfates.

The metal ions described above can be introduced into the open frameworks via complexation with the organic linking moieties in framework backbones or by ion exchange.

Carbonaceous Material

The carbonaceous material enriching an open framework or used in the methods described herein may have at least one nitrogen atom, at least one sulfur atom, at least one —OH moiety, or at least one —COOH moiety. Such nitrogen atom, sulfur atom, —OH moiety, or —COOH moiety may coordinate with at least one metal ion of the open framework. Examples of suitable carbonaceous materials include chitosan, β-cyclodextrin, pyrrole, glucose, and citrate. A combination of carbonaceous materials, including any of the carbonaceous materials described herein, may enrich the open framework or used in the methods described herein.

The carbonaceous material may also have a combination nitrogen atoms, sulfur atoms, —OH moieties, and —COOH moieties. For example, the carbonaceous material may have one or more —OH moieties and one or more —COOH moieties. One such example is citrate.

In some embodiments, the carbonaceous material is a saccharide, or a mixture of saccharides. Such saccharides may be monosaccharides or polysaccharides. The saccharides may be a linear chain (e.g., unbranched or branched) or ring structure.

In other embodiments, the carbonaceous material has a chain or supramolecular structure of at least 5 carbon atoms, at least 8 carbon atoms, at least 10 carbon atoms, at least 15 carbon atoms, 50 carbon atoms, or between 8 and 50 carbon atoms.

In yet other embodiments, the carbonaceous material is a heterocyclic aromatic compound comprising at least one nitrogen atom, at least one sulfur atom, or any combination thereof. At least one of the nitrogen and/or sulfur atoms present in the carbonaceous material may coordinate with the metal ions present in the open framework (e.g., MOF). In one embodiment, the carbonaceous material is a heterocyclic aromatic compound comprising at least one nitrogen atom. In one variation, the heterocyclic aromatic compound has 5 to 50 carbon atoms in the ring structure. In another variation, the heterocyclic aromatic compound is unsubstituted. In yet other variations, the heterocyclic aromatic compound is substituted with one or more substituents. Suitable heterocyclic aromatic compound may include, for example, pyrrole, aniline, pyridine, imidazole, triazole and their derivatives. In one embodiment, the heterocyclic aromatic compound is pyrrole, which may unsubstituted or substituted.

Ratio of Starting Materials

The ratio of the (i) organic linking compounds, (ii) metal compounds, and (iii) carbonaceous material used may affect the structure of composite produced, and the degree of carbon enrichment of the open frameworks produced. In some embodiments, the molar ratio of the (i) organic linking compounds, (ii) metal compounds, and (iii) carbonaceous material used is at least 8:1:1 to 1:8:8.

Liquid Medium

The methods described herein may be carried out in a liquid medium, e.g., in an aqueous or non-aqueous system. The use of a liquid medium can help the organic linking compounds, the metal compounds, and the carbonaceous material come into better contact with each other when undergoing the mechanochemical processing. For example, in one embodiment, the method may involve grinding the (i) organic linking compounds, (ii) metal compounds, and (iii) carbonaceous material in a liquid medium. In another example, the method may involve stirring the (i) organic linking compounds, (ii) metal compounds, and (iii) carbonaceous material in a liquid medium.

The liquid medium may include one solvent or a mixture of solvents. Certain solvents used may dissolve at least a portion of the starting materials used in the mechanochemical methods described herein. The liquid medium may be polar or nonpolar. The liquid medium may include, for example, n-alkanes, n-alcohols, aromatic solvents, chlorinated solvents, ether solvents, ketone solvents, or any mixtures thereof. In certain embodiments, liquid medium may include, for example, water, pentane, hexane, methanol, ethanol, n-propanol, isopropanol, benzene, toluene, xylene, chlorobenzene, nitrobenzene, cyanobenzene, aniline, naphthalene, naphthas, acetone, 1,2,-dichloroethane, methylene chloride, chloroform, carbon tetrachloride, tetrahydrofuran, dimethylformamide, dimethylsulfoxide, N-methylpyrollidone, dioxane, dimethylacetamide, diethylformamide, thiophene, pyridine, ethanolamine, triethylamine, ethylenediamine, or any mixtures thereof.

In some embodiments of the method, the liquid medium is less than 15 wt %, less than 10 wt %, or less than 5 wt % of the materials undergoing mechanochemical processing.

Additional Steps

The methods described herein to produce the composites may include one or more additional steps. For example, in some embodiments, the method further includes heating the composite produced after the mechanochemical processing step. The composite may be heated to a temperature suitable to carbonize the composite. The composite may be further carbonized under inert gas or air to obtain carbon-enriched carbon/metal clusters.

The carbonization temperature may be between 300° C. and 1000° C., or between 300° C. and 600° C., or between 500° C. and 1000° C. The carbonization temperature may vary depending on the type of open framework. For example, when the open framework is a zeolitic imidazolate framework, the carbonization temperature may, in certain embodiments, be between 500° C. and 1000° C. In one variation, the composite is subjected to a melt diffusion process after mechanochemical processing.

The methods described herein may also include further functionalizing the composites produced. The organic linking compounds incorporated into the composite have one or more reactive functional groups that can be chemically transformed by a suitable reactant to further functionalize the linking moieties for complexation of the metal ion(s). Thus, in one variation, the method further includes functionalizing the composite produced from the mechanochemical processing step. In another variation, the method further includes: heating the composite produced from the mechanochemical processing step; and further functionalizing the composite produced from the heating step.

Reactants suitable for use to further functionalize the composite may include any reactants suitable for coordinating with or chelating the one or more metal ions in the open frameworks of the composite. The reactants may be used to generate a chelating group for the addition of a metal. Suitable reactants may include, for example, unsubstituted or substituted heterocycloalkyls, R′C(═O)R″, or R′C(═O)OC(═O)R″, wherein R′ and R″ are each independently H, alkyl, aryl, OH, alkoxy, alkenes, alkynes, sulfur-containing groups (e.g., thioalkoxy), silicon-containing groups, nitrogen-containing groups (e.g., amides), oxygen-containing groups (e.g., ketones and aldehydes), halogen (e.g., chloro, fluoro, bromo, iodo), nitro, amino, cyano, boron-containing groups, phosphorus-containing groups, carboxylic acids, or esters. For example, in one variation of the method where the composite is further functionalized, the reactant may be a heterocycle having 1 to 20 ring carbon atoms, with 1 to 3 ring heteroatoms independently selected from nitrogen, oxygen and sulfur.

It should be understood that a “heterocycle” is a ring-containing structure of molecule having one or more ring heteroatoms independently selected from nitrogen, oxygen and sulfur. The heterocycle may be saturated or unsaturated, and the heterocycle may contain more than one ring. When the heterocycle contains more than one ring, the rings may be fused or unfused. Fused rings generally refer to at least two rings sharing two atoms therebetween.

Suitable reactants include, for example,

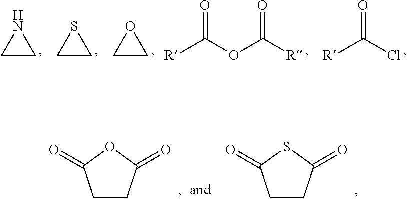

where R′ and R″ as are defined above.

Suitable methods to further functionalize the composites produced by the mechanochemical methods described herein are described, for example, in US 2012/0130113 (which is hereby incorporated herein by reference specifically with respect to paragraphs [0048]-[0053]).

The methods described herein may also include further carbonizing the functionalized carbon-enriched composites. The functionalized carbon-enriched composites may be carbonized by heating the composite to a suitable temperature. As discussed above, the carbonization temperature may be between 300° C. and 1000° C., or between 300° C. and 600° C., or between 500° C. and 1000° C. Any suitable methods or techniques known in the art may be employed to carbonize the composites.

When the MOF composites are carbonized, the metal ions may partially dissociate from the organic linking groups of the MOF and yield metal ions embedded in a conductive porous carbon matrix that is derived from the organic linking groups of the MOF.

For example, the carbonization of a MOF composite can be illustrated with respect to a MIL-53 composite. It is generally known in the art that MIL-53 includes at least one of the following moiety:

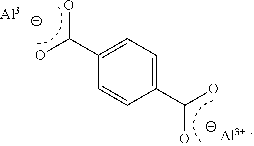

Without wishing to be bound by any theory, when MIL-53 is carbonized, the aluminum ions may partially dissociate from the carboxylic groups and yield Al₂O₃ (alumina) embedded in a conductive porous carbon matrix that is derived from the 1,4-benzenedicarboxylic acid linkers of MIL-53. Further, the alumina may be produced at a sub-nano scale according to the methods described herein; and the alumina (in the form of Al³⁺) may evenly be distributed in nano scale within the carbon matrix formed. When the methods described herein are employed, conglomeration is not typically observed, whereas severe clustering is typically observed when alumina is coated onto the lithium metal oxide using techniques and methods presently known in the art.

In some variations, the carbon matrix produced from carbonizing MIL-53 may be depicted as having at least one moiety as follows:

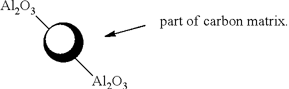

More generally, in other variations, the carbon matrix produced from carbonizing metal-organic frameworks may be depicted as having at least one moiety as follows:

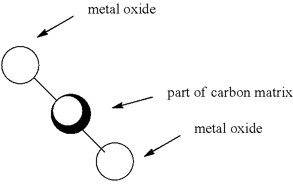

In certain embodiments of the carbonized MOF composite described herein or provided according to the methods described herein, the metal oxide particles are uniformly dispersed within the porous carbon matrix. In some variations, “uniformly dispersed” refers to metal oxide particles spaced in a repeating pattern within a carbon matrix. In one variation, such metal oxide particles may be uniformly dispersed in a carbon matrix when a metal-organic framework shell is pyrolyzed.

### Structure, Characterization and Other Properties of the Carbon-Enriched Composites

The methods provided herein yield composites made up of open frameworks in which the metal ion(s) of the metal compound(s) coordinate with or chelate the organic linking compound(s) to form one-, two- or three-dimensional structures that are porous. Thus, provided herein are also composites made up of porous open frameworks.

The carbonaceous material used to enrich the open frameworks has one or more functional groups, such as one or more nitrogen atoms, one or more sulfur atoms, one or more —OH groups, and/or one or more —COOH groups. One or more of such functional groups coordinates with the metal ions of the open framework. Through such coordination, in some embodiments, the carbonaceous material may cover or coat the surface of at least a portion of the open framework, or incorporate into one or more pores or channels of the open framework, or both.

The composites provided herein or produced according to the methods described herein may be characterized using any suitable methods and techniques known in the art. For example, the composite may be characterized by X-ray powder diffraction (XRPD), infrared (IR) spectroscopy, scanning electron microscope (SEM), nitrogen adsorption-desorption isotherms, and thermal gravimetric analysis (TGA).

Types of Open Frameworks

In some embodiments, the methods provided herein may yield composites that have metal organic frameworks (MOFs). The MOFs of the composites have structures that are based on repeating cores of bidentate or polydentate organic ligands coordinating with metal ions. In certain embodiments of the composites provided herein, MOF cores have M-L-M connectivity, where M is any suitable metal ion described herein, and L is any suitable organic ligand described herein. The repeating cores form a porous framework, and the carbonaceous material used in the mechanochemical methods described herein may occupy at least a portion of the pores.

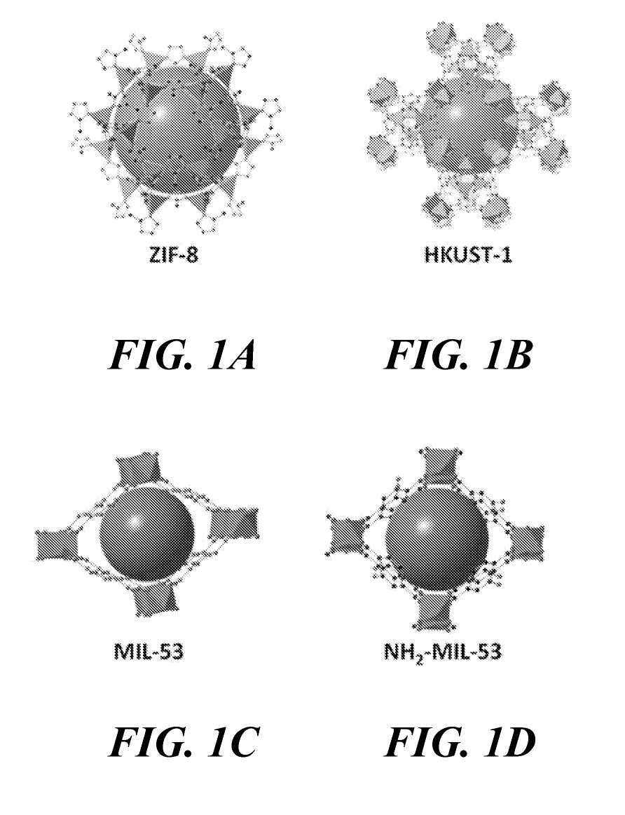

In some embodiments, the methods provided herein may yield composites that have zeolitic imidazolate frameworks (ZIFs). Such frameworks are made up of repeating cores with a zeolite-type structure. The ZIFs of the composite provided herein or produced according to the mechanochemical methods described herein are based on repeating cores of metal nodes tetrahedrally coordinated by imidazolate or imidazolate-derivative structures. Suitable ZIF structures are further described in, for example, US 2010/0186588 (which is hereby incorporated herein by reference specifically with respect to paragraphs [0005]-[0013], [0053], [0055]-[0069], and FIGS. 1A-1E, 3A, 3B, and 4E).

For example, when imidazole or imidazole-derivatives are used as the organic linking compounds in the mechanochemical methods described herein, the imidazole moiety (or derivative thereof) can lose a proton to form an imidazolate moiety (or derivative thereof). In certain embodiments of the composites provided herein, the core of the ZIF composite may have a formula of T-(Im)-T, where “Im” is imidazolate (or derivative thereof), and “T” is a tetrahedrally-bonded metal ion. Such repeating cores form a porous framework. In certain embodiments, imidazolate or imidazolate-derivative structures may include, for example, heterocyclic rings such as unsubstituted imidazolate, unsubstituted benzimidazolate, or imidazolate or benzimidazolate substituted with alkyl (e.g., methyl), nitro, cyano, or halo (e.g., chloro) groups, wherein one or more carbon atoms on the imidazolate or benzimidazolate may be replaced with a nitrogen atom (to the extent chemically feasible).

The structures of such ZIFs are known in the art. For example, it is recognized that ZIF-8 is made up of repeating core units of zinc ions coordinating with 2-methyl imidazole, and such repeating core units form a porous framework. Thus, in a ZIF-8 composite, the carbonaceous material may occupy at least a portion of the pores of the ZIF-8.

The composites may be neutral or charged. In certain embodiments where the composite is charged, the composite may coordinate with one or more counterions. For example, counter cations may include H⁺, Na⁺, K⁺, Mg₂⁺, Ca₂⁺, Sr₂⁺, ammonium ion, alkyl-substituted ammonium ions, and aryl-substituted ammonium ions; and counter anions may include F, Cl⁻, Br, I⁻, ClO⁻, ClO₂⁻, ClO₃⁻, ClO₄⁻, OH⁻, NO₃⁻, NO₂⁻, SO₄⁻, SO₃⁻, PO₃⁻, CO₃⁻, PF₆⁻ and organic counter ions such as acetate CH₃CO₂⁻, and triphlates CF₃SO₃⁻. Such counterions may be present from, for example, the metal compound used in the methods described herein.

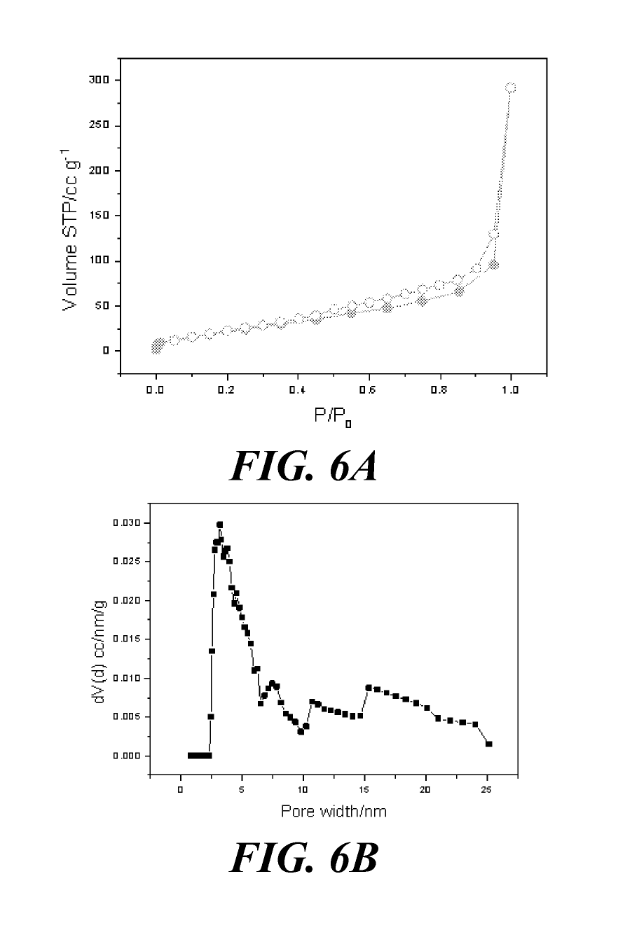

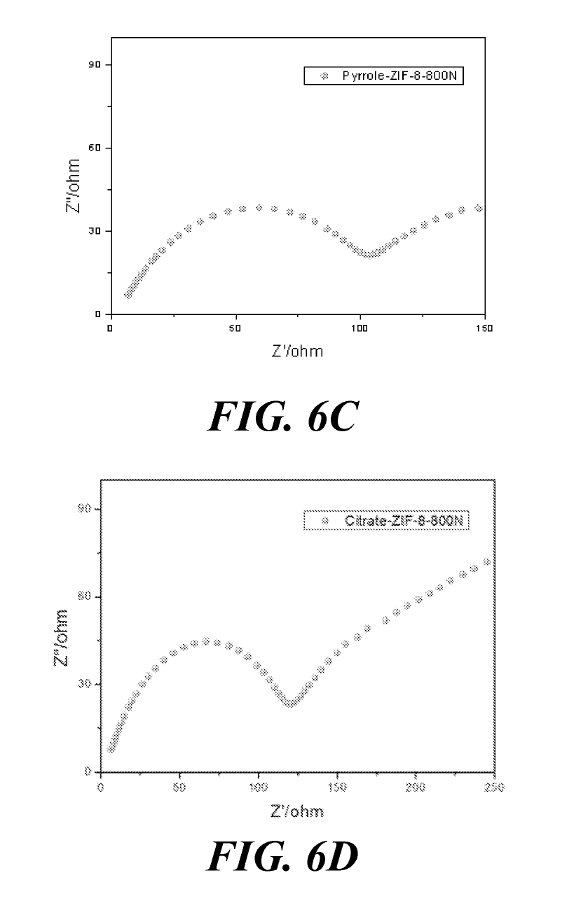

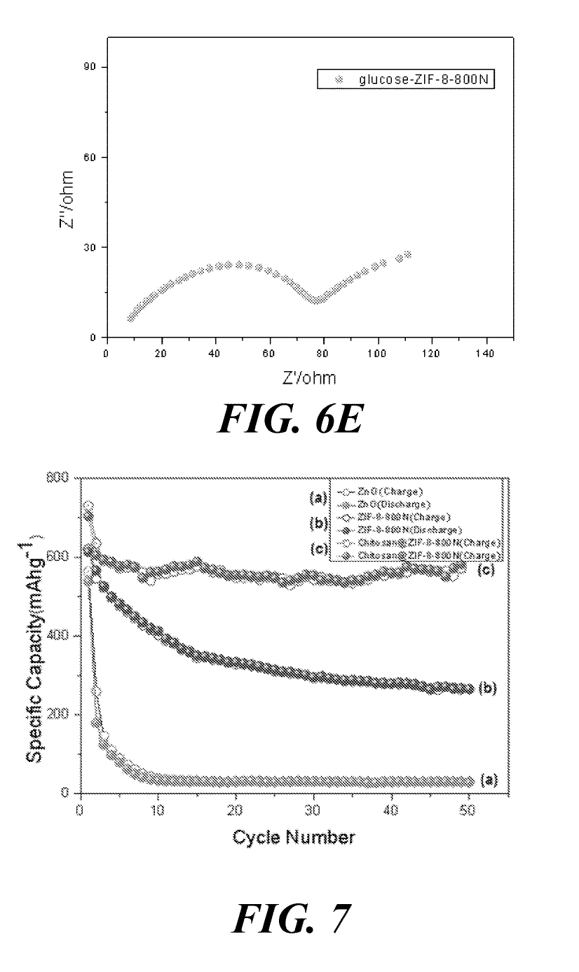

The mechanochemical methods described herein may be employed to produce open frameworks having structures as described in, for example, US2012/0259117 (which is hereby incorporated herein by reference specifically with respect to paragraphs [0006], [0051]-[0071], Schemes 1-3, and FIGS. 6A, 6B and 6C); US 2012/0130113 (which is hereby incorporated herein by reference specifically with respect to paragraphs [0008]-[0010], [0040]-[0047], and FIGS. 1A-D); and US 2013/0023402 (which is hereby incorporated herein by reference specifically with respect to paragraphs [0004]-[0007], [0073]-[0078], and FIGS. 1, 5-16, 37, 38, 40-43).

In some aspects, provided is a composite produced according to any of the mechanochemical methods described herein. In some embodiments, provided is a composite produced according to any mechanochemical methods involving grinding, as described herein. In some embodiments, provided is a composite produced according to any mechanochemical methods involving stirring, as described herein.

In other aspects, the composites provided herein or produced according to the mechanochemical methods described herein have an open framework with a repeating core of structure M-L-M, wherein M is a metal ion as described herein, and L is an organic linking moiety as described herein.

In some embodiments of the composite, the M-L-M structure may be selected from

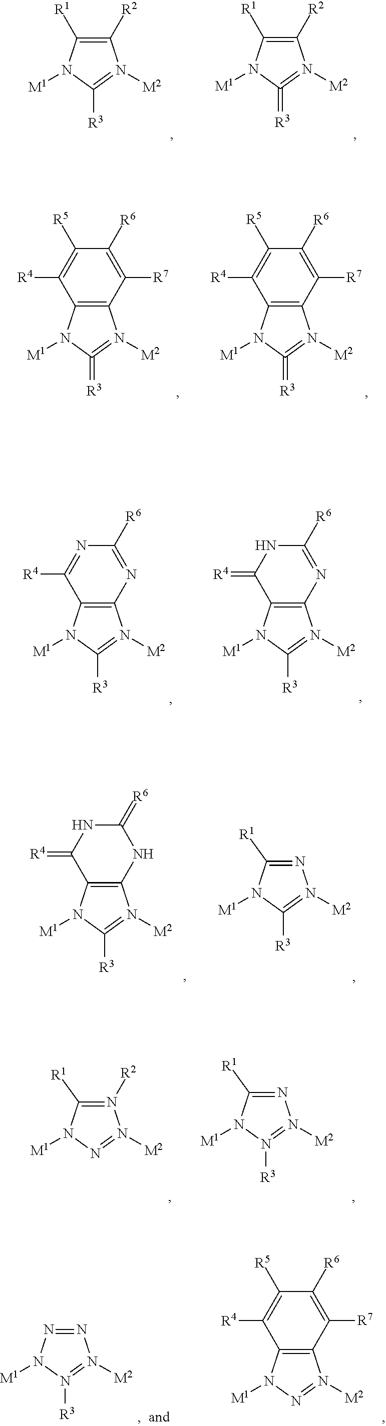

wherein:

each R¹, R², R³, R⁴, R⁵, R⁶ and R⁷ (when present) is independently selected from the group consisting of H, NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, As(SH)₃, CH(R^{a}SH)₂, C(R^{a}SH)₃, CH(R^{a}NH₂)₂, C(R^{a}NH₂)₃, CH(R^{a}OH)₂, C(R^{a}OH)₃, CH(R^{a}CN)₂, C(R^{a}CN)₃,

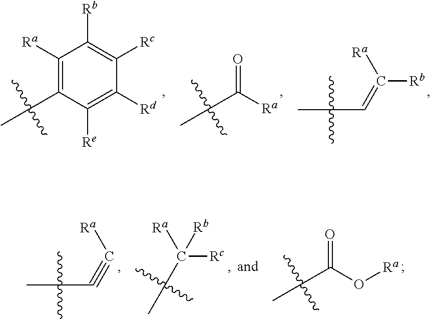

each R^{a}, R^{b}, and R^{c} (when present) is independently selected from the group consisting of H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, and As(SH)₃; and each M¹ and M² is independently selected from the group consisting of Zn²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co³⁺, Rh²⁺, Rh⁺, Ir²⁺, Ir⁺, Ni²⁺, Ni⁺, Pd²⁺, Pd⁺, Pt²⁺,Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

In other embodiments, the composite has a M-L-M structure of:

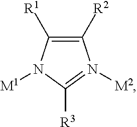

wherein:

each R¹ and R² is independently hydrogen, aryl (e.g., C₅₋₂₀ aryl, or C₅₋₆ aryl), alkyl (e.g. C₁₋₂₀ alkyl, or C₁₋₁₀ alkyl, or C₁₋₄ alkyl), halo (e.g., Cl, F, Br, or I), cyano, or nitro; or R¹ and R² are taken together with the carbon atoms to which they are attached to form a five- or six-membered heterocycle comprising 1, 2, or 3 nitrogen atoms;

R³ is hydrogen or alkyl; and

each M¹ and M² is independently Zn²⁺, Cu²⁺, Cu⁺, or Al³⁺.

In certain embodiments of the composite, each R¹ and R² is hydrogen. In certain embodiments of the composite, each R¹ and R² is independently alkyl (e.g. C₁₋₂₀ alkyl, or C₁₋₁₀ alkyl, or C₁₋₄ alkyl). In certain embodiments of the composite, R³ is hydrogen. In certain embodiments of the composite, R³ is alkyl (e.g. C₁₋₂₀ alkyl, or C₁₋₁₀ alkyl, or C₁₋₄ alkyl). In one embodiment of the composite, R³ is methyl. In certain embodiments of the composite, each R¹ and R² is independently alkyl; and R³ is hydrogen. In one embodiment, each R¹ and R² is methyl; and R³ is hydrogen. In certain embodiments of the composite, each R¹ and R² is hydrogen; and R³ is alkyl. In one embodiment, each R¹ and R² is hydrogen; and R³ is methyl. In yet another embodiment of the composite, each R¹, R² and R³ is hydrogen.

In certain embodiments of the composite, each M¹ and M² is Zn²⁺.

In certain embodiments, the composite has a M-L-M structure selected from

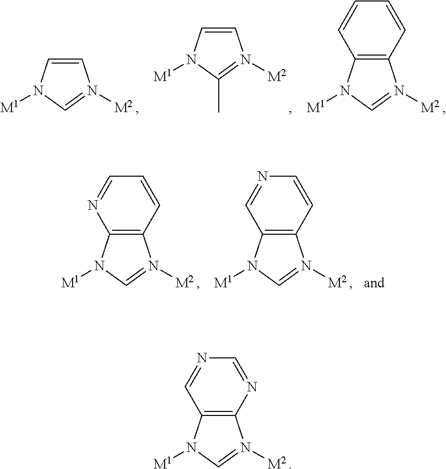

In other embodiments of the composite, the M-L-M has a structure wherein L is selected from:

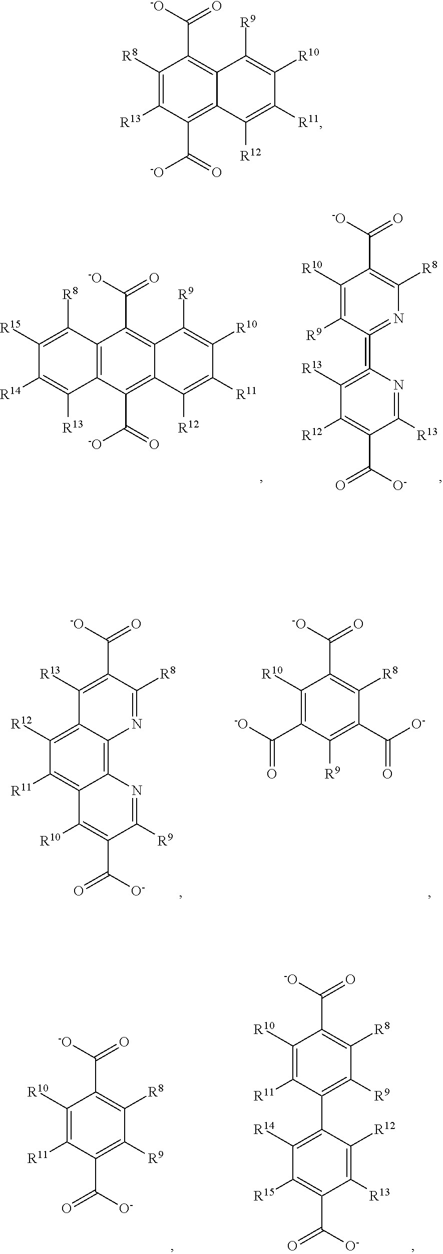

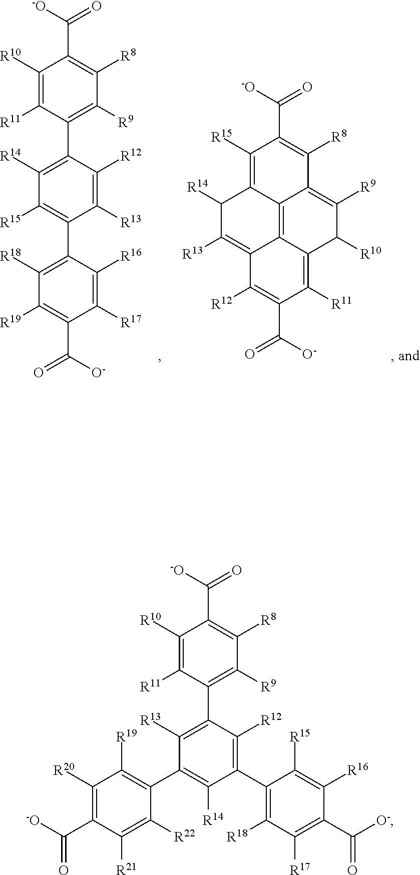

wherein:

each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is independently selected from the group consisting of H, NH₂, CN, OH, ═O, ═S, Br, Cl, I, F,

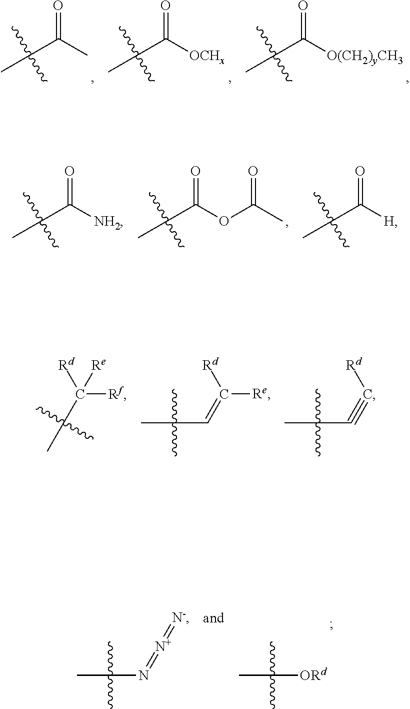

x and y (when present) is independently 1, 2 or 3; and

each R^{d}, R^{e} and R^{f} (when present) is independently H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, or Sn(SH)₄; and

wherein each M is independently selected from the group consisting of Zn²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

It should be understood that the carboxylate group(s) of the ligand (L) coordinates with the metal ion (M). In certain embodiments of the composite, each M is independently Zn²⁺, Cu²⁺, Cu⁺, or Al³⁺. In one embodiment, each M is Zn²⁺.

The open frameworks described above may have any suitable topologies known in the art. In certain embodiments of the composites described above, the open framework has a topology selected from the group consisting of ABW, AGO, AEI, AEL, AEN, AET, AFG, AFI, AFN, AFO, AFR, AFS, AFT, AFX, AFY, AHT, ANA, APC, APD, AST, ATN, ATO, ATS, ATT, ATV, AWO, AWW, BEA, BIK, BOG, BPH, BRE, CAN, CAS, CFI, CGF, CGS, CHA, CHI, CLO, CON, CZP, DAC, DDR, DFO, DFT, DOH, DON, EAB, EDI, EMT, EPI, ERI, ESV, EUO, FAU, FER, GIS, GME, GOO, HEU, IFR, ISV, ITE, JBW, KFI, LAU, LEV, LIO, LOS, LOV, LTA, LTL, LTN, MAZ, MEI, MEL, MEP, MER, MFI, MFS, MON, MOR, MSO, MTF, MTN, MTT, MTW, MWW, NAT, NES, NON, OFF, OSI, PAR, PAU, PHI, RHO, RON, RSN, RTE, RTH, RUT, SAO, SAT, SBE, SBS, SBT, SFF, SGT, SOD, STF, STI, STT, TER, THO, TON, TSC, VET, VFI, VNI, VSV, WIE, WEN, YUG and ZON, or any combinations thereof.

Carbon Enrichment

One or more functional groups of the carbonaceous material, e.g., nitrogen atom, sulfur atom, —OH group, or —COOH group, coordinates with one or more metal ions (M). For example, when the open framework produced is ZIF, and when the carbonaceous material is a saccaride, such as glucose, one or more —OH groups of the glucose may coordinate with one or more zinc ions of the ZIF:

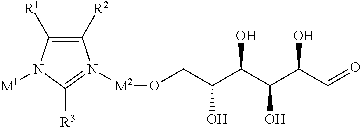

In other examples, when the open framework produced is a metal organic framework having cobalt ions, and when the carbonaceous material is a heterocyclic aromatic compound, such as pyrrole, the nitrogen atom of the pyrrole may coordinate with one or more cobalt ions of the MOF:

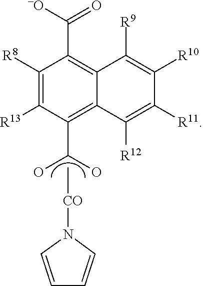

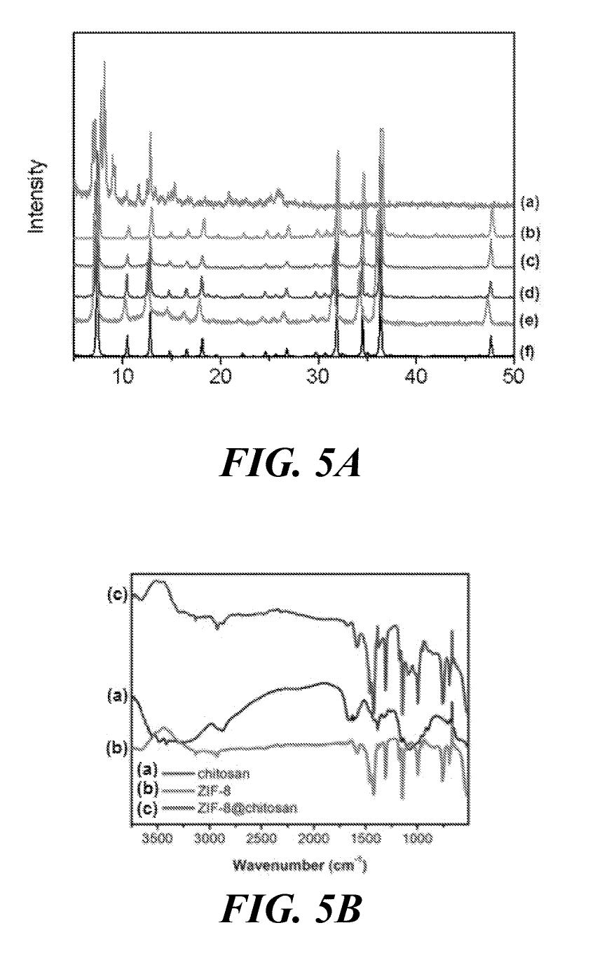

In one aspect, provided is a carbon-enriched ZIF-8 composite. For example, in one embodiment, provided is a chitosan-enriched ZIF-8 composite having an IR pattern (e.g., a FT-IR pattern) substantially as shown in FIG. 5B. As seen in the FT-IR pattern of FIG. 5B, the absorptions caused by the stretching and vibrations of free —OH and —NH₂ on chitosan are largely reduced in the chitosan-enriched ZIF-8 composite, indicating strong interactions of these functional groups with zinc ions on the surface of ZIF-8.

It should be understood that the term “substantially as shown in” when referring, for example, to a pattern (e.g., XRPD pattern, or IR pattern), includes a pattern that is not necessarily identical to those depicted herein, but that falls within the limits of experimental error or deviations when considered by one of ordinary skill in the art.

Surface Area of the Composite

In some embodiments of the composites, the carbonaceous material evenly, or substantially evenly, covers the surface of the open framework. For example, as shown in FIGS. 6A and 6B, when the carbonaceous material evenly covers the surface of ZIF-8, most of the micropores are observed to be blocked. When the carbonaceous material evenly, or substantially evenly, covers the surface of the open framework, the pore size distribution may be narrowed to two sharp peaks representing the micropore region (e.g., the intrinsic pores from MOF internal channels) and the macropore region (e.g., pores generated in-between the carbon and MOF particles). One of skill in the art would know the methods and techniques suitable for determining the micropore and macropore regions of a given MOF.

Pores in the Composite

The composites provided herein or produced according to the methods described herein are porous. As used herein, “pores” refers to the cavities and/or channels of the composite. Pore size can be determined by any methods or techniques known in the art. For example, pore size can be calculated using density functional theory (DFT) or X-ray crystallography (e.g., single crystal data).

Certain open frameworks have one pore type, which the radii of the pores are substantially identical. Such open frameworks having one pore type include, for example, ZIF-8 and MIL-53. Other open frameworks may have two or more pore types. Such open frameworks having two or three different pore types include, for example, HKUST-1 and MOF-5.

In some embodiments, the composite has an average pore size of less than 10 Å, less than 9 Å, less than 8 Å, or less than 7 Å; or between 3 Å and 10 Å. In other embodiments, the composite has an average pore size between 2 nm and 100 nm.

The pores of the composite may be interconnected by apertures, which may be in the form of channels and/or windows. As used herein, “aperature diameter” refers to the largest diameter of the aperatures in the composite. Aperature diameter may be determined using any suitable methods or techniques known in the art. For example, the aperature diameter of the composite may be determined by measuring the aperature diameter of the corresponding open framework without coordination of the carbonaceous material. The aperature diameter of an open framework (without coordination of the carbonaceous material) may, for example, be determined by X-ray crystallography (e.g., single crystal data).

In some embodiments, the composites have an average aperature diameter of less than 10 Å, less than 9 Å, less than 8 Å, or less than 7 Å; or between 3 Å and 10 Å, or between 3 Å and 7 Å. In certain embodiments, the composites have: (i) an average pore size between 3 Å and 10 Å, or between 2 nm and 100 nm; (ii) an average aperature diameter between 3 Å and 7 Å.

It should be understood that each pore of the composite may host carbonaceous molecules, depending on the pore size and aperture diameter.

Loading and Distribution of Carbonaceous Material

The carbonaceous material covers at least a portion of the surface of the open framework, and/or is incorporated into at least a portion of the one or more pores of the composite provided herein or produced according to the methods described herein. In some embodiments of the composite, the carbonaceous material evenly covers the surface of the open framework. In other embodiments of the composite, the carbonaceous material is evenly incorporated into the one or more pores.

The carbon-enrichment of the open framework can be determined by comparing the IR spectrum of the mixture of (i) one or more organic linking compounds, (ii) one or more metal compounds, and (iii) carbonaceous material before grinding, and the IR spectrum of the composite produced after grinding. One of skill in the art would recognize various ways to determine whether an open framework is carbon-enriched. For example, an open framework is “carbon-enriched” when the IR peak corresponding to the functional group of the carbonaceous material (e.g., the nitrogen atom, the sulfur atom, the —OH group, or the —COOH group) is present. Unless otherwise stated, the IR spectrum provided herein are generated by a KBr pallet on a FT-IR spectrometer.

Size

The size of the composite can affect its capacity retention. As used herein, “size” (or particle size) refers to the longest distance from edge to edge of the composite. Various factors affect the size of the composite. Size may vary depending, for example, on the type of mechanochemical processing (e.g., grinding versus stirring), as well as the parameters of the processing (e.g., frequency of grinding or stirring).

For example, when the mechanochemical grinding method described herein is employed, the composite produced may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm. In certain embodiments, the mechanochemical grinding method described herein is used to produce composites having ZIFs. Thus, in one embodiment, the ZIF composite may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm.

When the mechanochemical stirring method described herein is employed, the resulting composite may have a size less than 20 microns, less than 10 microns, less than 5 microns, or less than 1 micron; or between 50 nm and 10 microns, between 50 nm and 20 microns, between 100 nm and 10 microns, between 200 nm and 10 microns, between 200 nm and 5 microns, or between 1 micron to 5 microns. In certain embodiments, the resulting ZIF composite (e.g., ZIF-8 composite) produced by grinding may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm.

Size of the composite may be determined using any suitable methods or techniques known in the art. For example, size may be determined by scanning electron microscope (SEM). One of skill in the art would recognize that the methods described herein may produce composites having a distribution of sizes.

Such size distribution may be expressed as an average size (e.g., average particle size). For example, when the mechanochemical grinding method described herein is employed, the composite may have an average size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm.

When the mechanochemical stirring method described herein is employed, the composite may have an average size less than 20 microns, less than 10 microns, less than 5 microns, or less than 1 micron; or between 50 nm and 10 microns, between 50 nm and 20 microns, between 100 nm and 10 microns, between 200 nm and 10 microns, between 200 nm and 5 microns, or between 1 micron to 5 microns.

The size distribution of the composite may be expressed as a D50 size distribution or a D90 size distribution. As used herein, “D50 size distribution” refers to the maximum diameter in which 50% of the composites (or composite particles) lies below the stated value (also referred to as the median). “D90 size distribution” refers to the maximum diameter below which 90% of the composites (or composite particles) lie below the stated value.

For example, when the mechanochemical grinding method described herein is employed, the composite produced may have a D50 size distribution between 20 nm and 100 nm. The composite produced may also have a D90 size distribution between 20 nm and 500 nm. For example, in one exemplary embodiment, the ZIF composite produced by the mechanochemical grinding method may have a D90 size distribution of about 50 nm. In another example, the ZIF composite produced by the mechanochemical grinding method may have a D90 size distribution of about 200 nm.

When the mechanochemical stirring method described herein is employed, the composite produced may have a D50 size distribution between 50 nm and 10 microns. The composite produced may also have a D90 size distribution between 50 nm and 20 microns. For example, in an exemplary embodiment, the composite produced by the mechanochemical stirring method may have a D90 size distribution about 1-2 microns.

Impurities

The composites provided herein or produced according to the methods described herein may have less than 25 wt %, less than 20 wt %, or less than 15 wt % of impurities. Such impurities may include, for example, zinc oxide, nitrate, and 2-methyl imidazole.

### Electrodes

The composites provided herein or produced according to the methods described herein may be suitable for use as electrode materials in batteries, such as Li-ion batteries. For example, the electrodes may include composites with open porosities and channels. Both carbonized and non-carbonized composites described herein may be used for the electrodes. In some variations, the electrodes may include composites that are made up of mono-dispersed metal/metal clusters, evenly distributed across the open frameworks.

Thus, in one aspect, provided is an electrode comprising: a composite (or a plurality of the composites) provided herein or produced according to any of the methods described herein, and binder. In some variations, the electrode further includes additional carbonaceous material. In some embodiments of the electrode, the composite is at least 25 wt % or at least 30 wt % of the electrode. In some variations of the electrode, the composite is a MOF composite. In one variation of the electrode, the composition is a ZIF composite.

In some embodiments, provided is an anode that includes: a carbon-enriched open framework composite (or a plurality of such composites) provided herein or produced according to any of the methods described herein, and binder. In an exemplary embodiment, the cathode includes carbon-enriched ZIF (e.g., carbon-enriched ZIF-8), and binder.

In other embodiments, provided is an anode that includes: a carbon-enriched open framework composite (or a plurality of such composites) provided herein or produced according to any of the methods described herein, and binder. In an exemplary embodiment, the cathode includes carbon-enriched ZIF (e.g., carbon-enriched ZIF-8), and binder.

Carbonaceous material, in addition to the carbon-enriched open frameworks, may be used use in preparing electrodes of batteries, including for example Li-ion batteries. For example, such additional carbonaceous material may be carbon black.

Any binders known in the art suitable for use in preparing electrodes of batteries, including for example Li-ion batteries, may be used. For example, the binder may be poly(vinylidene fluoride) (PVdF), carboxyl methyl cellulose (CMC), and alginate, or any combinations thereof.

Any suitable methods and techniques known in the art may be employed to prepare the cathode or anode. See e.g., Hong Li et al. Adv. Mater. 2009, 21, 4593-460.

It should be understood that the composites provided herein or produced according to any of the methods described herein functions as active material in the electrode. The composites in the electrode may be characterized by one or more properties, including for example charge/discharge capacity, decay rate, retention rate, and coulombic efficiency. One of skill in the art would recognize the suitable methods and techniques to measure capacity of the composite used in an electrode. For example, capacity may be measured by standard discharging and charging cycles, at standard temperature and pressure (e.g., 25° C. and 1 bar). See e.g., Juchen Guo, et al., J. Mater. Chem., 2010, 20, 5035-5040.

Discharge Capacity

As used herein, “discharge capacity” (also referred to as specific capacity) refers to the capacity measured to discharge the cell. Discharge capacity can also be described as the amount of energy the composite contains in milliamp hours (mAh) per unit weight.

In some embodiments, the composites provided herein or produced according to any of the methods described herein have an average discharge capacity over an initial 10 cycles of at least 500 mAh/g, at least 600 mAh/g, at least 700 mAh/g, at least 800 mAh/g, at least 900 mAh/g, or at least 1,000 mAh/g at 0.1 C. In some embodiments, the composites provided herein or produced according to any of the methods described herein have an average discharge capacity over an initial 10 cycles of at least 200 mAh/g, at least 300 mAh/g, at least 400 mAh/g, at least 500 mAh/g, at least 600 mAh/g, at least 700 mAh/g, at least 800 mAh/g, at least 900 mAh/g, or at least 1,000 mAh/g at 0.5 C. For example, in certain embodiments, the composites provided herein or produced according to the methods described herein have an average discharge capacity over an initial 10 cycles of: (i) at least 600 mAh/g at 0.1 C; and (ii) at least 300 mAh/g at 05. C.

For example, in one example, carbon-enriched ZIF provided herein or produced according to the methods described herein (e.g., carbon-enriched ZIF-8) has an average discharge capacity over an initial 10 cycles of: (i) at least 400 mAh/g at 0.1 C; and (ii) at least 300 mAh/g at 0.5 C. It should be understood that 0.1 C and 0.5 C refers to different charging rates.

In some aspects, provided herein is an electrode material, e.g., for use in a lithium ion battery, that includes a carbonized composite, wherein the composite comprises a plurality of metal oxide particles dispersed in a carbon matrix having one or more pores, wherein additional carbonaceous material is incorporated into the open framework formed (e.g., covering the surface of the open framework and/or incorporated within the channels or pores of the open framework). In some variations of any of the foregoing embodiments, the electrode material has an average discharge capacity over an initial 300 cycles of at least 500 mAh/g at room temperature when discharged from 3V to 10 mV after the material is activated in the first cycle through a charge to 3V at a rate of 0.1 mV/s.

In some variations, the electrode material is an anode material, and the carbonized composite includes zinc oxide particles or aluminum oxide (alumina) particles, or a combination thereof, dispersed in a porous carbon matrix.

Decay Rate

As used herein, “decay rate” refers to the decrease in capacity as a function of given number of cycles. In some embodiments, the composite provided herein or produced according to any of the methods described herein has a decay rate at 0.1 C of less than 0.5%, less than 0.25%, or less than 0.1% per cycle.

Retention Rate

As used herein, “retention rate” refers to the capacity retained after 50 cycles, calculated as Q/Qᵢₙᵢₜᵢₐₗ. In some embodiments, the composites provided herein or produced according to any of the methods described herein have an average retention rate after 50 cycles of at least 60%, at least 65%, at least 70%, at least 80%, at least 85%, at least 90%, or at least 95%.

Coulombic Efficiency

As used herein, “coulombic efficiency” refers to the ratio of discharging over charging capacity. A high coulombic efficiency is desired (e.g., at or near 100%), which would indicate that the amount of charge going in is equal or close to equal the amount of charge coming out. Further, consistency of coulombic efficiency over cycles is desired, which would allow for consumption of less electrolytes and power in, for example, a battery, and provide better prediction of when the battery is charged and discharged.

The composites provided herein or produced according to any of the methods described herein have a coulombic efficiency that is significantly better than materials known in the art. Such improved coulombic efficiency may be due to various factors, including for example, the monodispersion and improved contact of the carbonaceous material with the open frameworks, conductive components and the electrolytes. Additionally, improved coulombic efficiency may be due to the size of the composites that result from the methods provided herein, as the diffusion path of electrolyte may be shorter and thus more efficient.

Such coulombic efficiency may, in certain embodiments, be achieved over at least 10 cycles, at least 20 cycles, at least 30 cycles, at least 40 cycles, or at least 50 cycles. In some embodiments, the composites provided herein or produced according to any of the methods described herein have an average coulombic efficiency of at least 60%, at least 70%, at least 80%, at least 85%, at least 90% or at least 95%. For example, in one embodiment, the composites have an average coulombic efficiency over about 50 cycles of at least 80%, at least 90%, or at least 95%.

### Batteries

The electrodes described herein may be used in a battery, including for example lithium-ion (Li-ion) batteries. Thus, in one aspect, provided is a Li-ion battery that includes: (i) an electrode, wherein the electrode includes a carbon-enriched open framework composite (or a plurality of such composites) provided herein or produced according to any of the methods described herein, and binder; and (ii) lithium ions. In some variations of the battery, the carbon-enriched composite used in the electrode is a carbonized carbon-enriched composite.

In some embodiments, provided is a battery (e.g., a Li-ion battery) that includes: (i) an anode, wherein the anode includes a carbon-enriched open framework composite (or a plurality of such composites) provided herein or produced according to any of the methods described herein, and binder; and (ii) a cathode. In an exemplary embodiment, the anode of the Li-ion battery includes carbon-enriched ZIF (e.g., carbon-enriched ZIF-8).

In other embodiments, provided is a battery (e.g., a Li-ion battery) that includes: (i) a cathode, wherein the cathode includes a carbon-enriched open framework composite (or a plurality of such composites) provided herein or produced according to any of the methods described herein, and binder; and (ii) an anode. In an exemplary embodiment, the cathode of the Li-ion battery includes carbon-enriched ZIF (e.g., carbon-enriched ZIF-8). Such carbon-enriched open framework composite may be further enriched to improve performance of the battery, including for example further enriching the carbon-enriched open framework composite with sulfur.

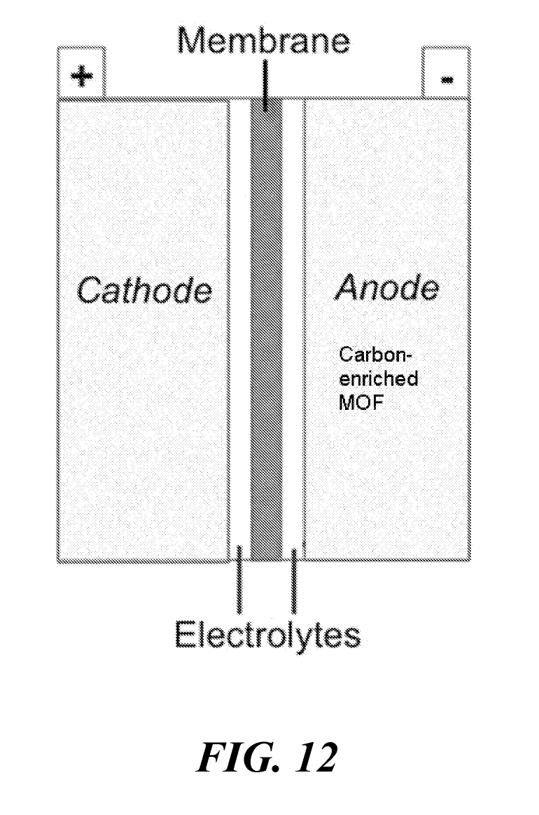

With reference to FIG. 12, an exemplary battery is depicted. In this exemplary battery, the anode is made up carbon-enriched MOF as described herein. It should be understood, however, that while the anode is depicted as having the composites as described herein, in other exemplary batteries, the battery may include a cathode made up of carbon-enriched MOF composite, and an anode without carbon-enriched MOF composite; or the battery may include an anode and a cathode both made up of carbon-enriched MOF composites. It should also be understood that any of the carbon-enriched open framework composites as described herein may be used as electrode materials.

With reference again to FIG. 12, the exemplary battery may include any suitable membrane or other separator that separates the cathode and anode, while allowing ions to pass through. The electrodes and the membrane are submerged in an electroyle. Any suitable electrolytes may be used in the battery. For example, in Li-ion batteries, the electrolytes may be bis-(trifluoromethanesulfonyl)imide lithium (LiTFSI), LiNO₃, and/or lithium hexafluorophosphate (LiPF6) in solvents or solvent mixtures (e.g., organic solvent or solvent mixtures that may include carbonates, carboxylates, esters and/or ethers). When the battery charges, the ions (e.g., lithium ions in the case of a Li-ion battery) move through the electrolyte from the cathode to anode. During discharge, the ions move back to the cathode.

The batteries, including for example Li-ion batteries, described above may be suitable for use in portable wireless devices (e.g., cell phones) and electric vehicles. Other forms of batteries that may use the composites include, for example, metal-air batteries. The composites provided herein may also be suitable for use as the active electrode materials in fuel cells and super capacitors (e.g., pseudo-capacitors, hybrid capacitors, and Faradaic capacitors).

### Enumerated Embodiments

The following enumerated embodiments are representative of some aspects of the invention.
1. A method for producing a carbon-enriched composite, comprising mechanochemically processing (i) one or more organic linking compounds, (ii) one or more metal compounds, and (iii) carbonaceous material to produce the carbon-enriched composite.
2. The method of embodiment 1, wherein the carbon-enriched composite comprises an open framework produced from the one or more organic linking compounds and the one or more metal compounds, and wherein the open framework comprises at least one metal ions, and

wherein the carbonaceous material comprises at least one nitrogen atom, at least one sulfur atom, at least one —OH moiety, at least one —COOH moiety, or any combinations thereof, and

wherein at least one of the nitrogen atom, at least one sulfur atom, —OH moiety, or —COOH moiety coordinates with at least one of the metal ions of the open framework.
3. The method of embodiment 1 or 2, wherein the carbonaceous material is a saccharide.
4. The method of embodiments 2 or 3, wherein the carbonaceous material has a chain or supramolecular structure of at least 8 carbon atoms.
5. The method of any one of embodiment 1 to 4, wherein the carbonaceous material is a heterocyclic aromatic compound comprising at least one nitrogen atom, at least one sulfur atom, or any combination thereof.
6. The method of embodiment 1 or 2, wherein the carbonaceous material is chitosan, β-cyclodextrin, pyrrole, glucose, citrate, or any combinations thereof.
7. The method of any one of embodiments 2 to 6, wherein between 0.05% to 0.5% by weight of the open framework composite is the carbonaceous material.
8. The method of any one of embodiments 1 to 7, wherein the mechanochemical processing is performed by grinding.
9. The method of embodiment 8, wherein the grinding is performed without external heating.
10. The method of embodiment 8 or 9, wherein the grinding is performed using a ball mill.
11. The method of any one of embodiments 1 to 10, wherein the carbon-enriched composite has an average size less than 500 nm.
12. The method of embodiment 11, wherein the carbon-enriched composite has an average size between 20 nm and 500 nm.
13. The method of any one of embodiments 1 to 7, wherein the mechanochemical processing is performed by stirring.
14. The method of embodiment 13, wherein the stirring is performed at room temperature.
15. The method of embodiment 13 or 14, wherein the composite has an average size less than 10 microns.
16. The method of embodiment 15, wherein the composite has an average size between 200 nm and 10 microns.
17. The method of any one of embodiments 1 to 16, wherein the open framework is a metal organic framework (MOF).
18. The method of embodiment 17, wherein the one or more organic linking compounds are independently:

an aryl with at least one phenyl ring substituted with at least one —COOH moiety, or

a heteroaryl with at least pyridyl ring substituted with at least one —COOH moiety.
19. The method of embodiment 18, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
20. The method of any one of embodiments 1 to 16, wherein the open framework is a zeolitic imidazolate framework (ZIF).
21. The method of embodiment 20, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.
22. The method of any one of embodiments 1 to 16, wherein the open framework is ZIF-8, ZIF-67, MOF-199, MOF-199, HKUST-1, MIL-53, NH₂-MIL-53, or MOF-5.
23. The method of any one of embodiments 1 to 22, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd2+, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb4+, Pb²⁺, As⁵⁺, As³⁺, As⁺, Sb⁵⁺, Sb³⁺, Sb⁺, Bi⁵⁺, Bi³⁺, or Bi⁺.
24. A carbon-enriched composite produced according to any one of embodiments 1 to 23.
25. A method for producing a carbonized composite, comprising carbonizing a carbon-enriched composite produced according to the method of any one of embodiments 1 to 23.
26. The method of embodiment 25, wherein the carbon-enriched composite is carbonized at a temperature between 300° C. and 1000° C.
27. The method of embodiment 25, wherein the carbon-enriched composite is carbonized at a temperature between 300° C. and 600° C.
28. The method of embodiment 25, wherein the open framework is a zeolitic imidazolate framework (ZIF), and wherein the carbon-enriched composite is carbonized at a temperature between 500° C. and 1000° C.
29. The method of any one of embodiments 25 to 28, wherein the carbonized composite has a porous carbon structure with mono-dispersed metal clusters.
30. A composite produced according to the method of any one of embodiments 1 to 29.
31. The composite of embodiment 30, wherein the composite comprises an open framework comprising at least one metal ions and carbonaceous material,

wherein the carbonaceous material comprises at least one nitrogen atom, at least one sulfur atom, at least one —OH moiety, at least one —COOH moiety, or any combinations thereof, and

wherein at least one of the nitrogen atom, at least one sulfur atom, —OH moiety, or —COOH moiety coordinates with at least one of the metal ions of the open framework.
32. The composite of embodiment 31, wherein the open framework is a metal organic framework (MOF).
33. The composite of embodiment 32, wherein the open framework is a zeolitic imidazolate framework (ZIF).
34. The composite of embodiment 33, wherein the composite has an average size less than 500 nm.
35. The composite of embodiment 30, wherein the open framework is ZIF-8, ZIF-67, MOF-199, MOF-199, HKUST-1, MIL-53, NH₂-MIL-53, or MOF-5.
36. The composite of embodiment 35, wherein the open framework is ZIF-8.
37. The composite of any one of embodiments 30 to 36, wherein the composite has an average discharge capacity over an initial 10 cycles of: (i) at least 600 mAh/g at 0.1 C; and (ii) at least 300 mAh/g at 0.5 C, or both (i) and (ii).
38. The composite of any one of embodiments 30 to 37, wherein the composite has a decay rate at 0.1 C of less than 0.5% per cycle.
39. The composite of any one of embodiments 30 to 38, wherein the composite has an average retention rate after 50 cycles of at least 80%.
40. The composite of any one of embodiments 30 to 39, wherein the composite has an average coulombic efficiency over 50 cycles of at least 95%.
41. An electrode, comprising:

a carbon-enriched composite of any one of embodiments 30 to 40; and binder.
42. The electrode of embodiment 41, wherein the electrode is an anode.
43. A battery, comprising:

an anode of embodiment 42; and

lithium ions.
44. An electrode material for use in a lithium ion battery, comprising:

a carbonized composite, wherein the composite comprises:
a plurality of metal oxide particles dispersed in a carbon matrix having one or more pores, and
carbonaceous material, wherein the carbonaceous material (i) covers at least a portion of the surface of the composite, or (ii) is incorporated into at least a portion of the one or more pores, or both (i) and (ii); and

wherein the electrode material has an average discharge capacity over an initial 300 cycles of at least 500 mAh/g at room temperature when discharged from 3V to 10 mV after the material is activated in the first cycle through a charge to 3V at a rate of 0.1 mV/s.
45. The electrode material of embodiment 44, wherein the carbonaceous material evenly covers at least a portion of the surface of the composite.
46. The electrode material of embodiment 44 or 45, the plurality of metal oxide particles are mono-dispersed in the carbon matrix.
47. The electrode material of any one of embodiments 44 to 46, wherein the carbonized composite is obtained by a method comprising:

mechanochemically processing (i) one or more organic linking compounds, (ii) one or more metal compounds, and (iii) carbonaceous material to produce a carbon-enriched metal organic framework (MOF) composite; and carbonizing the carbon-enriched MOF composite to produce the carbonized composite.
48. The electrode material of embodiment 47, wherein the one or more organic linking compounds are independently:

an aryl with at least one phenyl ring substituted with at least one —COOH moiety, or

a heteroaryl with at least pyridyl ring substituted with at least one —COOH moiety.
49. The electrode material of embodiment 47, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
50. The electrode material of embodiment 47, wherein the MOF is a zeolitic imidazolate framework (ZIF).
51. The electrode material of embodiment 47, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.
52. The electrode material of embodiment 47, wherein the MOF is ZIF-8, ZIF-67, MOF-199, MOF-199, HKUST-1, MIL-53, NH₂-MIL-53, or MOF-5.
53. The electrode material of embodiment 47, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.
54. The electrode material of any one of embodiments 44 to 53, wherein the electrode material is an anode material.
55. A lithium ion battery comprising:

a cathode;

an anode of embodiment 54; and

a separator between the cathode and anode.
56. A composite comprising a metal-organic framework (MOF) having one or more pores and carbonaceous material, wherein:

(i) the carbonaceous material evenly covers the surface of the MOF; or

(ii) the carbonaceous material is evenly incorporated into the one or more pores of the MOF; or

both (i) and (ii).
57. The composite of embodiment 56, wherein the carbonaceous material is a saccharide.
58. The composite of embodiment 56, wherein the carbonaceous material has a chain or supramolecular structure of at least 8 carbon atoms.
59. The composite of embodiment 56, wherein the carbonaceous material is a heterocyclic aromatic compound comprising at least one nitrogen atom, at least one sulfur atom, or any combination thereof.
60. The composite of embodiment 56, wherein the carbonaceous material is chitosan, β-cyclodextrin, pyrrole, glucose, citrate, or any combinations thereof.
61. The composite of any one embodiments 56 to 60, wherein between 0.05% to 0.5% by weight of the composite is the carbonaceous material.
62. The composite of any one of embodiments 56 to 61, wherein the MOF is a zeolitic imidazolate framework (ZIF).
63. The composite of embodiment 62, wherein the ZIF is ZIF-8, and wherein the composite has an average discharge capacity over an initial 10 cycles of: (i) at least 600 mAh/g at 0.1 C; and (ii) at least 300 mAh/g at 0.5 C, or both (i) and (ii).
64. The composite of any one of embodiments 56 to 63, wherein the composite has one or more of the following properties (A)-(C):

(A) a decay rate at 0.1 C of less than 0.5% per cycle; or

(B) an average retention rate after 50 cycles of at least 80%; or

(C) an average coulombic efficiency over 50 cycles of at least 95%.
65. A method for producing a carbon-enriched composite, comprising mechanochemically processing (i) one or more organic linking compounds, (ii) one or more metal compounds, and (iii) carbonaceous material to produce the carbon-enriched composite.
66. The method of embodiment 65, wherein the carbon-enriched composite comprises a metal organic framework (MOF) produced from the one or more organic linking compounds and the one or more metal compounds, and wherein the open framework comprises at least one metal ions, and

wherein the carbonaceous material comprises at least one nitrogen atom, at least one sulfur atom, at least one —OH moiety, at least one —COOH moiety, or any combinations thereof, and

wherein at least one of the nitrogen atom, at least one sulfur atom, —OH moiety, or —COOH moiety coordinates with at least one of the metal ions of the open framework.
67. The method of embodiment 65 or 66, wherein the one or more organic linking compounds are independently:

an aryl with at least one phenyl ring substituted with at least one —COOH moiety, or

a heteroaryl with at least pyridyl ring substituted with at least one —COOH moiety.
68. The method of embodiment 65 or 66, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
69. The method of embodiment 65 or 66, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.
70. The method of embodiment 65 or 66, wherein the MOF is a zeolitic imidazolate framework (ZIF).
71. The method of embodiment 70, wherein the ZIF is ZIF-8.
72. The method of embodiment 65 or 66, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.
73. The method of any one of embodiments 65 to 72, wherein the carbonaceous material is a saccharide.
74. The method of any one of embodiments 65 to 72, wherein the carbonaceous material has a chain or supramolecular structure of at least 8 carbon atoms.
75. The method of any one of embodiments 65 to 72, wherein the carbonaceous material is a heterocyclic aromatic compound comprising at least one nitrogen atom, at least one sulfur atom, or any combination thereof.
76. The method of any one of embodiments 65 to 72, wherein the carbonaceous material is chitosan, β-cyclodextrin, pyrrole, glucose, citrate, or any combinations thereof.
77. A carbon-enriched composite produced according to any one of embodiments 65 to 76.
78. A method for producing a carbonized composite, comprising carbonizing a carbon-enriched composite produced according to the method of any one of embodiments 65 to 77.
79. The method of embodiment 78, wherein the carbonized composite has a porous carbon structure with mono-dispersed metal clusters.
80. A carbonized composite produced according to the method of embodiment 78 or 79.
81. An electrode, comprising:

a carbon-enriched composite of any one of embodiments 56 to 64 and 77; and

binder.
82. The electrode of embodiment 81, wherein the electrode is an anode.
83. A battery, comprising:

an anode of embodiment 82; and

lithium ions.

### EXAMPLES

The following Examples are merely illustrative and are not meant to limit any aspects of the present disclosure in any way.

### Comparative Example 1a

### Synthesis of ZIF-8

This Example demonstrates the synthesis of ZIF-8, a zinc 2-methyl imidazole MOF. Zinc oxide (0.407 g, 5.02 mmol) and 2-methyl imidazole (0.8211 g, 8.54 mmol) were added to a steel tank, with five steel balls. The contents were milled them at high speed for 15 min. Then 500 μL methanol was added into and milling was continued for another 15 min. The resulting products were washed with methanol (30 mL) for three times and dried at 85° C. Powder X-ray diffraction (PXRD) was used to analyze a sample of the resulting product. The PXRD was obtained using monochromatized Cu-Kα (λ=1.54178 Å) incident radiation by a D8 Advance Bruker powder diffractometer operating at 40 kV voltage and 50 mA current.

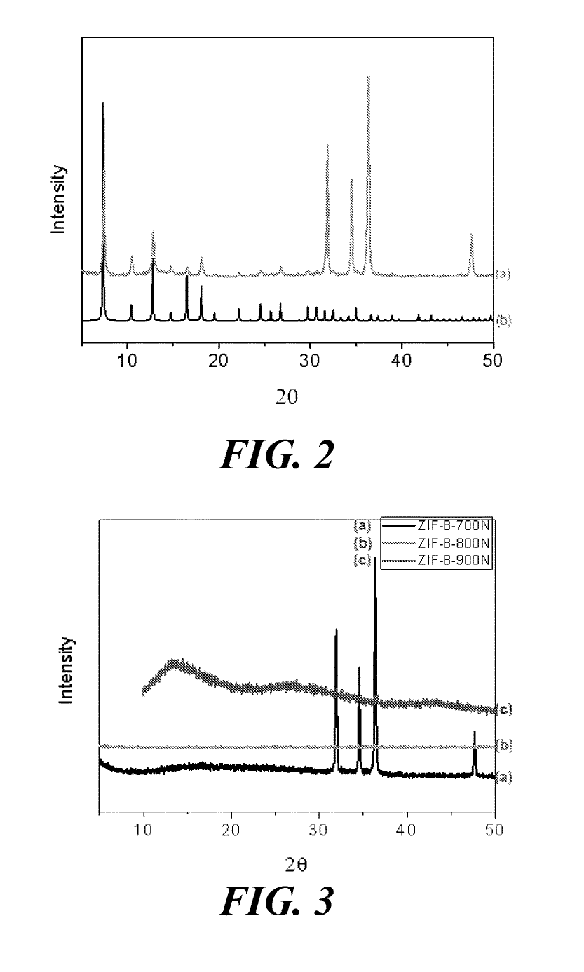

FIG. 2 depicts the PXRD pattern of the synthesized ZIF-8, referring to pattern (a), and the PXRD pattern simulated from the single crystal x-ray diffraction data of the MOF obtained from the Cambridge Crystallographic Data Centre used as a control for this Example, referring to pattern (b). Comparison of the two patterns in FIG. 2 confirms that the product resulting from the synthesis in this Example is ZIF-8.

### Comparative Example 1b

### Preparation of Carbonized ZIF-8

This Example demonstrates the carbonization of ZIF-8. Three samples of the ZIF-8 prepared in Comparative Example 1a above were transferred to a tube furnace. The samples were heated at 700° C., 800° C. and 900° C., respectively, under nitrogen with a heating rate of 5° C./min to pyrolyze the ZIF. After reaching the target temperature, the resulting carbonized composites were cooled down to room temperature. PXRD was used to analyze samples of the carbonized composites according to the procedure set forth in Comparative Example 1a above.

FIG. 3 depicts the PXRD pattern of carbonized ZIF-8. Pattern (a) refers to ZIF-8 carbonized at 700° C. under nitrogen (“ZIF-8-700N”); pattern (b) refers to ZIF-8 carbonized at 800° C. under nitrogen (“ZIF-8-800N”); and pattern (c) refers to ZIF-8 carbonized at 900° C. under nitrogen (“ZIF-8-900N”). Pattern (a) shows four peaks, which represent the zinc-nitride clusters. At higher temperatures, as seen in pattern (c), a hump in the pattern (between 10-20 degrees 2θ) represents graphite diffraction, indicating that the zinc-nitride clusters are not aggregating.

### Comparative Example 1c

### Electrochemical Tests

This Example demonstrates the use of the carbonized ZIF-8 prepared in Comparative Example 1b above.

To prepare the anodes, 80 wt % carbonized ZIF-8, 10 wt % Super P carbon black and 10 wt % poly vinylidene fluoride (PVdF) binder were mixed in N-methyl pyrrolidinone (NMP) solution to form a slurry. The slurry was cast onto copper foil and dried under a vacuum at 120° C. for 12 h. Coin cells of CR2032 type were constructed inside an argon-filled glove box using a lithium metal foil as the negative electrode and the composite positive electrode separated by polypropylene microporous separator (Celgard). The electrolyte used was 1 M LiPF₆ in ethyl carbonate (EC) and diethyl carbonate (DMC) (1:1 in v/v).

Assembled coin cells were allowed to soak overnight and then were charged and discharged galvanostatically at 50 mA/g between 0.02 and 3.0 V using a Land battery tester at ambient temperature.

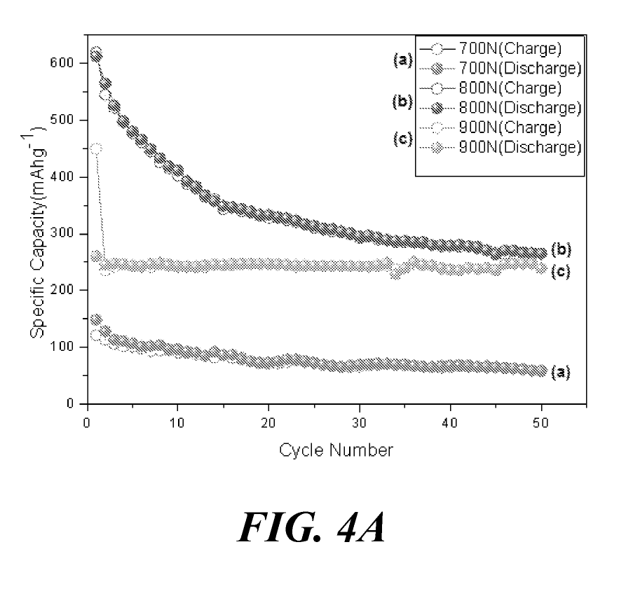

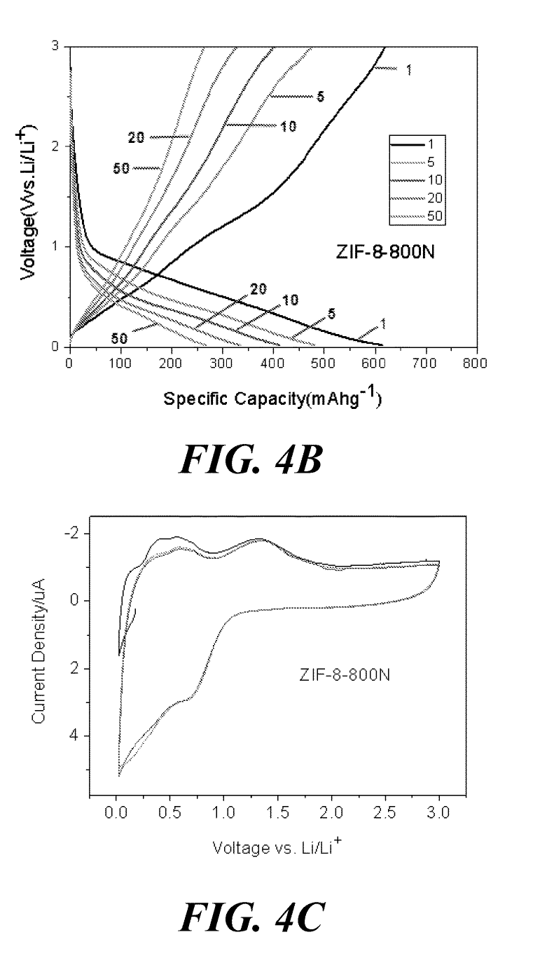

As seen in FIG. 4A, the electrochemical cycle tests of ZIF-8 carbonized at 800° C. shows the cell giving a higher overall stable compared to ZIF-8 carbonized at 700° C. and 900° C.

As seen in FIG. 4B, the discharging profile over cycles shows most of the capacity is obtained below 1V.

The cyclic voltammetry of carbonized ZIF-8 was recorded with a potentiostat (CHI 760E: CH Instrumental Inc.). The range of voltage was 20 mV-3.0 V with a scan rate of 0.1 mV/s. As seen in FIG. 4C, the redox peaks are observed around 1V, which suggests that this material would be suitable as an active anode material in lithium ion battery.

### Example 2a

### Synthesis of Carbon-Enriched ZIF-8

This Example demonstrates the synthesis of various carbon-enriched ZIF-8 composites, including chitosan-enriched ZIF-8, β-cyclodextrin-enriched ZIF-8, pyrrole-enriched ZIF-8, glucose-enriched ZIF-8, and citrate-enriched ZIF-8.

Zinc oxide (0.610 g, 7.52mmol) and 2-methyl imidazole (0.851 g, 8.85mmol) and carbonaceous material (0.210 g of chitosan, 0.208 g of β-cyclodextrin, 0.198 g of pyrrole and 500 μL of 0.1 M citrate solution) were put in a steel tank, with five steel balls. The contents of the steek tank were milled at high speed for 15 min. Then, 500 μL methanol was added into the tank, and milling was continued for another 15 min. The resulting products were washed with methanol (30 mL) for three times and dried at 85° C.

PXRD

Powder X-ray diffraction (PXRD) was used to analyze a sample of the resulting products. The PXRD was obtained using monochromatized Cu-Kα (λ=1.54178 Å) incident radiation by a D8 Advance Bruker powder diffractometer operating at 40 kV voltage and 50 mA current. The PXRD patterns of each carbon-enriched composite synthesized in this Example is depicted in FIG. 5A. Pattern (a) depcits citrate-enriched ZIF-8; pattern (b) depicts glucose-enriched ZIF-8; pattern (c) depicts pyrrole-enriched ZIF-8; pattern (d) depicts β-cyclodextrin-enriched ZIF-8; pattern (e) depicts chitosan-enriched ZIF-8; and pattern (f) ZIF-8 synthesized in Comparative Example 1a.

IR

Each carbon-enriched composite synthesized above was characterized by IR spectroscopy. The chitosan-enriched ZIF-8 composite was characterized by IR, and its IR spectra is provided in FIG. 5B. As seen in FIG. 5B, the absorptions caused by the stretching and vibrations of free —OH and —NH₂ on chitosan are largely reduced in the chitosan-enriched ZIF-8 composite, indicating strong interactions of these functional groups with zinc ions on the surface of ZIF-8.

### Example 2b

### Preparation of Carbonized Carbon-Enriched Composites

This Example demonstrates the carbonization of the carbon-enriched composites prepared in Example 2a above. Each of the carbon-enriched composites produced in Example 2a above were carbonized at 800° C. according to the procedure set forth in Comparative Example 1b above.

Nitrogen Sorption Isotherm

For the chitosan-enriched ZIF-8 carbonized under 800° C. under nitrogen, the nitrogen sorption isotherm was measured at 77 K on a sample of using a Quantachrome Instrument ASiQMVH002-5 after pretreatment by heating the samples under vacuum at 150° C. for 6 h. As seen in FIG. 6A, nitrogen adsorption and desorption isotherms of chitosan-enriched ZIF-8 carbonized under 800° C. show decrease in gas uptake in low pressure indicating the disappearance of micropores and emerging of meso-macro pores.

Pore Size Distribution

For the chitosan-enriched ZIF-8 carbonized under 800° C. under nitrogen, the pore size distribution was calculated by DFT. As seen in FIG. 6B, non-localized density function theory (NLDFT) calculation based on the nitrogen adsorption isotherm of chitosan-enriched ZIF-8 carbonized under 800° C. shows a broad pore size distribution.

Electrochemical Impedance

The electrochemical impedance of pyrrole-enriched, citrate-enriched, and glucose-enriched ZIF-8 carbonized at 800° C. under nitrogen, were measured using a potentiostat (CHI 760E: CH Instrumental Inc.) after 5 cycles at 50 mA/g. The frequency range was from 10⁻¹ to 10⁴ Hz. As seen in FIGS. 6C-6E internal resistance of the pyrrole-enriched, citrate-enriched, and glucose-enriched ZIF-8 carbonized at 800° C. are higher than that of chitosan-enriched ZIF-8 carbonized under 800° C.

ICP

Inductively coupled plasma (ICP) emission was tested by Varian 725 inductively coupled plasma emission spectrometer for ZIF-8 and chitosan-enriched ZIF-8 carbonized under 800° C. under nitrogen. ICP for ZIF-8 was observed to have Zn/ω of 37.2%, and for chitosan-enriched carbonized ZIF-8 of 29.5%.

### Example 2c

### Electrochemical Tests

This Example compares the electrochemical performance of ZnO, ZIF-8 carbonized at 800° C. under nitrogen, and chitosan-enriched ZIF-8 carbonized at 800° C. under nitrogen. Provided are also data for the electrochemical performance of the other carbonized carbon-enriched ZIF-8 prepared in Example 2b above. Anodes were prepared according to the procedure set forth in Comparative Example 1c above.

FIG. 7 provides results from the electrochemical cycle tests (charging and discharging capacities) of chitosan-enriched ZIF-8 carbonized at 800° C. under nitrogen, ZIF-8 carbonized at 800° C. under nitrogen and commercial zinc oxide. As seen in FIG. 7, improvements in capacity as well as the retention over cycles were observed when ZIF-8 enriched with chitosan was used compared to when ZIF-8 carbonized at 800° C. under nitrogen and commercial zinc oxide were used.

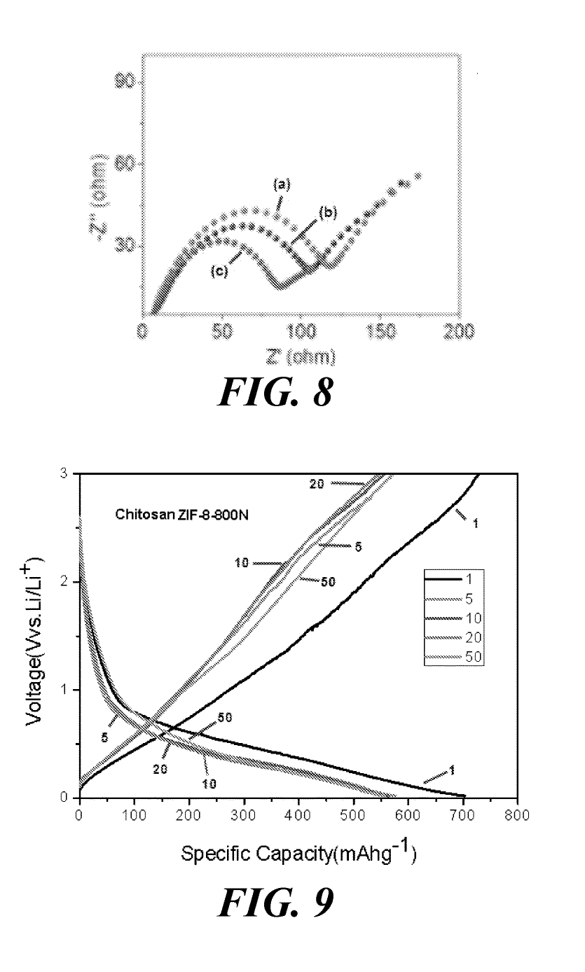

The electrochemical impedance was measured for ZnO, carbonized ZIF-8, and carbonized chitosan-enriched using a potentiostat (CHI 760E: CH Instrumental Inc.) after 5 cycles at 50 mA/g. The frequency range was from 10⁻¹ to 10⁴ Hz with an applied voltage of their own. FIG. 8 shows the effects of chitosan enrichment of ZIF-8 in reducing the internal resistance of the anode.

FIG. 9 provides the charging and discharging voltage profiles for the chitosan-enriched ZIF-8 carbonized at 800° C. under nitrogen. As seen in FIG. 9, most of the charging/discharging capacities are under 1V, which suggests that the material is suitable for use as an anode for lithium ion batteries.

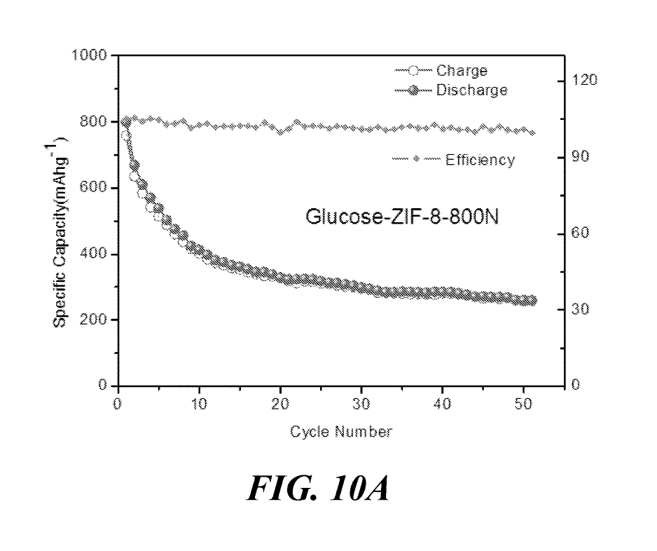

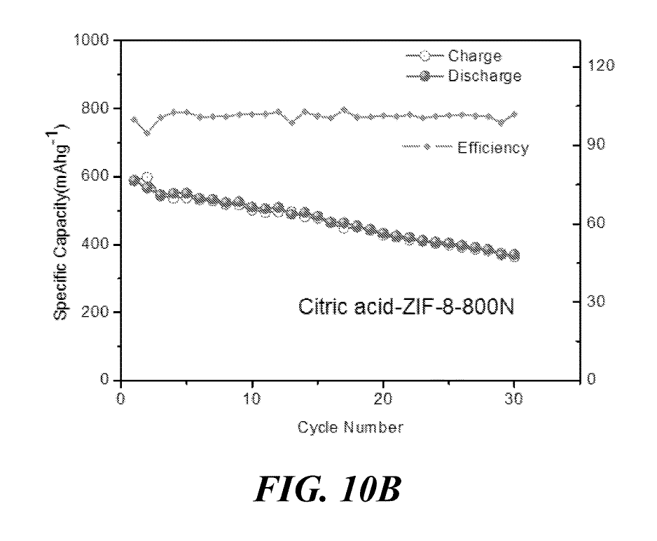

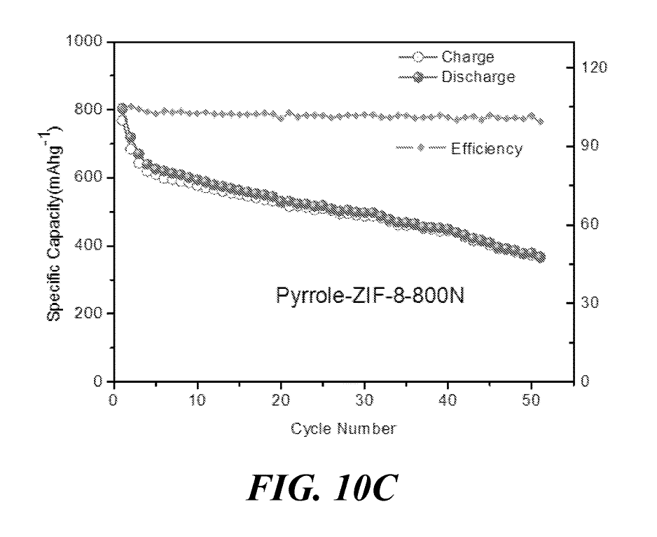

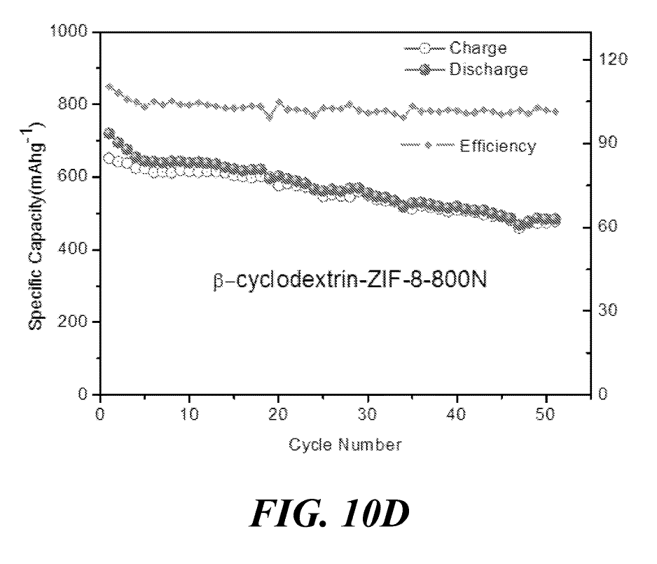

FIGS. 10A-10D provide data from the cycle tests of glucose-, citric acid-, pyrrole-, and cyclodextrin-enriched ZIF-8, respectively, carbonized at 800° C. under nitrogen. As seen in FIGS. 10A-10D, higher capacity and better retention was observed after enriching ZIF-8 with each carbonaceous material (i.e., glucose, citric acid, pyrrole, and cyclodextrin).

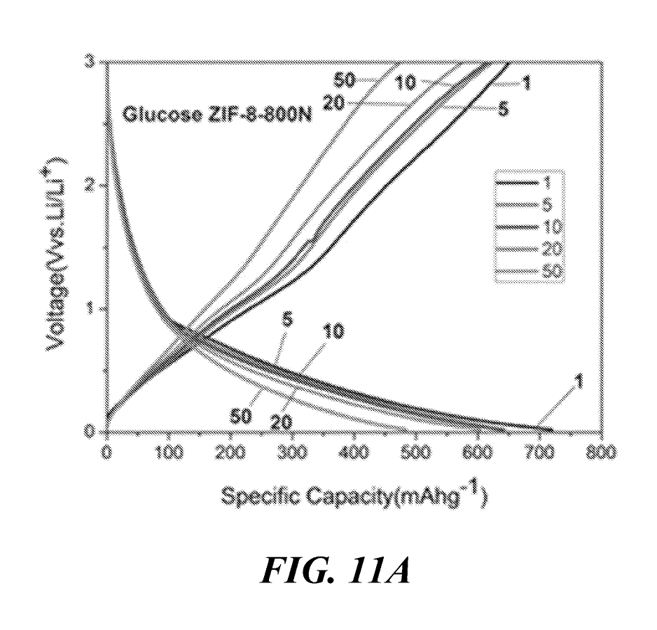

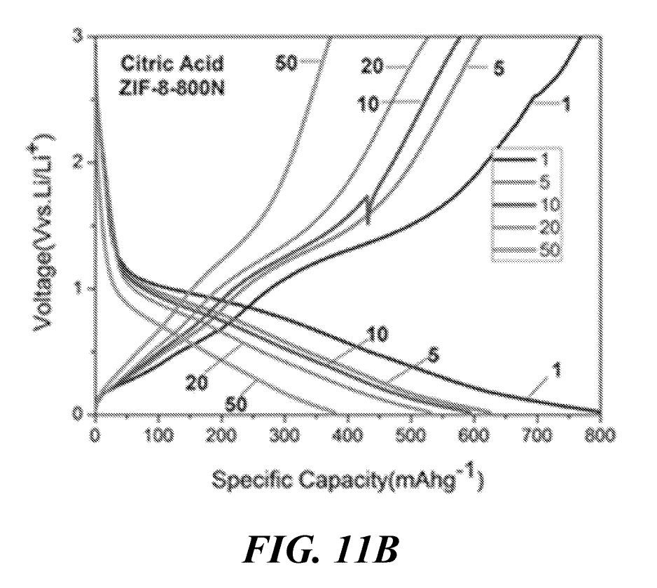

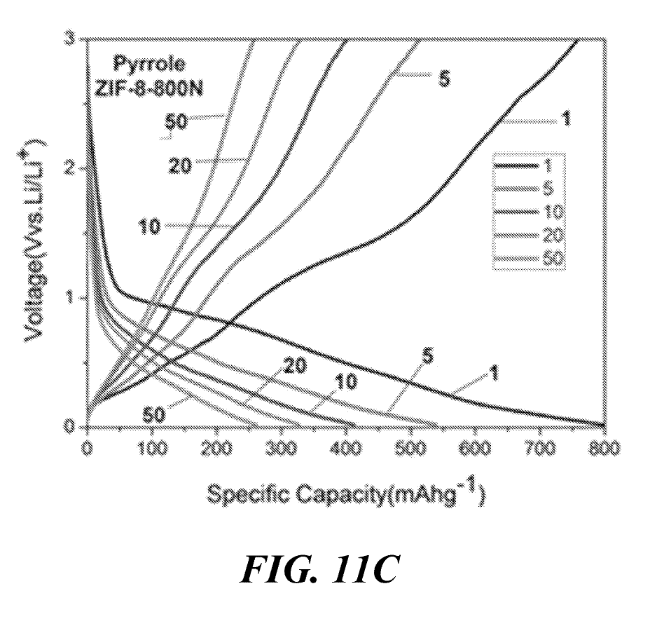

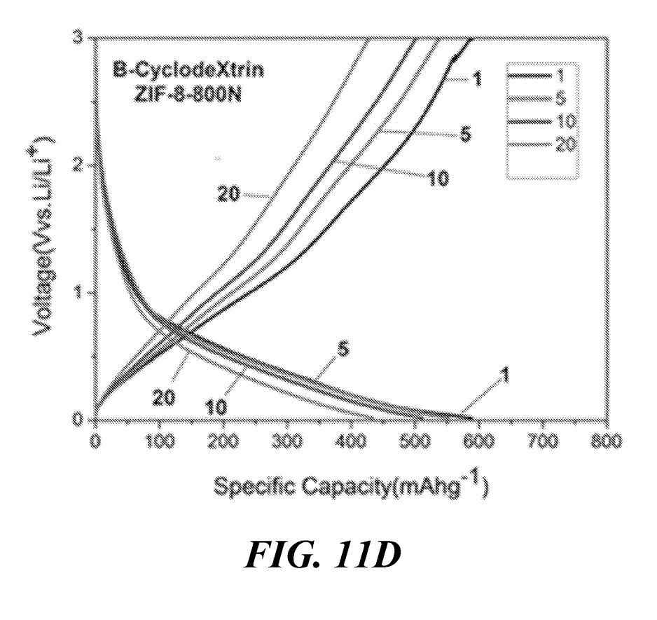

FIGS. 11A-11D provide the charging and discharging voltage profiles for the glucose-, citric acid-, pyrrole-, and cyclodextrin-enriched ZIF-8, respectively, carbonized at 800° C. under nitrogen. These figures show that most of the charging/discharging capacities are under 1V, which suggests that the material is suitable for use as an anode for lithium ion batteries.

1. An electrode material for use in a lithium ion battery, comprising:
a carbonized composite, wherein the composite comprises:
a plurality of metal oxide particles dispersed in a carbon matrix having one or more pores, and
carbonaceous material, wherein the carbonaceous material (i) covers at least a portion of the surface of the composite, or (ii) is incorporated into at least a portion of the one or more pores, or both (i) and (ii); and
wherein the electrode material has an average discharge capacity over an initial 300 cycles of at least 500 mAh/g at room temperature when discharged from 3V to 10 mV after the material is activated in the first cycle through a charge to 3V at a rate of 0.1 mV/s.

2. The electrode material of claim 1, wherein the carbonaceous material evenly covers at least a portion of the surface of the composite.

3. The electrode material of claim 1, the plurality of metal oxide particles are mono-dispersed in the carbon matrix.

4. The electrode material of claim 1, wherein the carbonized composite is obtained by a method comprising:
mechanochemically processing (i) one or more organic linking compounds, (ii) one or more metal compounds, and (iii) carbonaceous material to produce a carbon-enriched metal organic framework (MOF) composite; and
carbonizing the carbon-enriched MOF composite to produce the carbonized composite.

5. The electrode material of claim 4, wherein the one or more organic linking compounds are independently:
an aryl with at least one phenyl ring substituted with at least one —COOH moiety, or
a heteroaryl with at least pyridyl ring substituted with at least one —COOH moiety.

6. The electrode material of claim 4, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.

7. The electrode material of claim 4, wherein the MOF is a zeolitic imidazolate framework (ZIF).

8. The electrode material of claim 4, wherein the one or more organic linking compounds are independently:
a monocyclic five-membered heteroaryl having at least two nitrogen atoms, wherein two of the nitrogen atoms are configured in the 1- and 3-positions of the monocyclic five-membered ring, or
a bicyclic ring system made up of at least one five-membered ring having at least two nitrogen atoms, wherein two of the nitrogen atoms are configured in the 1- and 3-positions of the five-membered ring.

9. The electrode material of claim 4, wherein the MOF is ZIF-8, MOF-199, MOF-199, HKUST-1, MIL-53, NH₂-MIL-53, or MOF-5.

10. The electrode material of claim 4, wherein the one or more metal compounds independently comprise Mg²⁺, Ca²⁺, Sr²⁺, Ba²⁺, Sc³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, R²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.

11. The electrode material of claim 1, wherein the electrode material is an anode material.

12. A lithium ion battery comprising:
a cathode;
an anode of claim 11; and
a separator between the cathode and anode.

13. A composite comprising a metal--organic framework (MOF) having one or more pores and carbonaceous material, wherein:
(i) the carbonaceous material evenly covers the surface of the MOF; or
(ii) the carbonaceous material is evenly incorporated into the one or more pores of the MOF; or
both (i) and (ii).

14. The composite of claim 13, wherein the carbonaceous material is a saccharide.

15. The composite of claim 13, wherein the carbonaceous material has a chain or supramolecular structure of at least 8 carbon atoms.

16. The composite of claim 13, wherein the carbonaceous material is a heterocyclic aromatic compound comprising at least one nitrogen atom, at least one sulfur atom, or any combination thereof.

17. The composite of claim 13, wherein the carbonaceous material is chitosan, β-cyclodextrin, pyrrole, glucose, citrate, or any combinations thereof.

18. The composite of claim 13, wherein between 0.05% to 0,5% by weight of the composite is the carbonaceous material.

19. The composite of claim 13, wherein the MOF is a zeolitic imidazolate framework (ZIF).

20. The composite of claim 19, wherein the ZIF is ZIF-8, and wherein the composite has an average discharge capacity over an initial 10 cycles of: (i) at least 600 mAh/g at 0.1 C; and (ii) at least 300 mAh/g at 0.5 C, or both (i) and (ii).

21. The composite of claim 13, wherein the composite has one or more of the following properties (A)-(C):
(A) a decay rate at 0.1 C of less than 0.5% per cycle; or
(B) an average retention rate after 50 cycles of at least 80%; or
(C) an average coulombic efficiency over 50 cycles of at least 95%.

22. A method for producing a carbon-enriched composite, comprising mechanochemically processing (i) one or more organic linking compounds, (ii) one or more metal compounds, and (iii) carbonaceous material to produce the carbon-enriched composite.

23. The method of claim 22, wherein the carbon-enriched composite comprises a metal organic framework (MOF) produced from the one or more organic linking compounds and the one or more metal compounds, and wherein the open framework comprises at least one metal ions, and
wherein the carbonaceous material comprises at least one nitrogen atom, at least one sulfur atom, at least one —OH moiety, at least one —COOH moiety, or any combinations thereof, and
wherein at least one of the nitrogen atom, at least one sulfur atom, —OH moiety, or —COOH moiety coordinates with at least one of the metal ions of the open framework.

24. The method of claim 22, wherein the one or more organic linking compounds are independently:
an aryl with at least one phenyl ring substituted with at least one —COOH moiety, or
a heteroaryl with at least pyridyl ring substituted with at least one —COOH moiety.

25. The method of claim 22, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.

26. The method of claim 22, wherein the one or more organic linking compounds are independently:
a monocyclic five-membered heteroaryl having at least two nitrogen atoms, wherein two of the nitrogen atoms are configured in the 1- and 3-positions of the monocyclic five-membered ring, or
a bicyclic ring system made up of at least one five-membered ring having at least two nitrogen atoms, wherein two of the nitrogen atoms are configured in the 1- and 3-positions of the five-membered ring.

27. The method of claim 22, wherein the MOF is a zeolitic imidazolate framework (ZIF).

28. The method of claim 27, wherein the ZIF is ZIF-8.

29. The method of claim 22, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴, Pb²⁺, As⁵⁺, As³⁺, As⁺, Sb⁵⁺, Sb³⁺, Sb⁺, Bi⁵⁺, Bi³⁺, or Bi⁺.

30. The method of claim 22, wherein the carbonaceous material is a saccharide.

31. The method of claim 22, wherein the carbonaceous material has a chain or supramolecular structure of at least 8 carbon atoms.

32. The method of claim 22, wherein the carbonaceous material is a heterocyclic aromatic compound comprising at least one nitrogen atom, at least one sulfur atom, or any combination thereof.

33. The method of claim 22, wherein the carbonaceous material is chitosan, β-cyclodextrin, pyrrole, glucose, citrate, or any combinations thereof.

34. A carbon-enriched composite produced according to claim 22.

35. A method for producing a carbonized composite, comprising carbonizing a carbon--enriched composite produced according to the method of claim 22.

36. The method of claim 35, wherein the carbonized composite has a porous carbon structure with mono-dispersed metal clusters.

37. A carbonized composite produced according to the method of claim 35.

38. An electrode, comprising:
a carbon-enriched composite of claim 13; and
binder.

39. The electrode of claim 38, wherein the electrode is an anode.

40. A battery, comprising:
an anode of claim 39; and
lithium ions.
